(19) United States
(12) Patent Application Publication
(10) Pub. No.: US 2015/0046303 A1
(43) Pub. Date: Feb. 12, 2015

(54) MULTI-CURRENCY FINANCIAL CONSOLIDATION

(71) Applicants: Carmen Cerrelli, San Jose, CA (US); Daniel J. Berube, Milpitas, CA (US); Atanas Anguelov, Sunnyvale, CA (US); Sean Scott, Chilliwack (CA); William J. McGinley, San Jose, CA (US)

(72) Inventors: Carmen Cerrelli, San Jose, CA (US); Daniel J. Berube, Milpitas, CA (US); Atanas Anguelov, Sunnyvale, CA (US); Sean Scott, Chilliwack (CA); William J. McGinley, San Jose, CA (US)

(21) Appl. No.: 14/457,052

(22) Filed: Aug. 11, 2014

Related U.S. Application Data
(60) Provisional application No. 61/864,418, filed on Aug. 9, 2013.

(51) Int. Cl. G06Q 40/00

(52) U.S. Cl. CPC G06Q 40/12
USPC 705/30

(57) ABSTRACT

An electronic multinational consolidation system and method of combining and translating financial data by automatically applying the correct exchange rate based on predetermined accounting rules to each required general ledger, providing mapping tools to assure consistency across various general ledgers and, hence, accurate financial reporting and allowing for historical corrections to be made and brought forward to the current financial period.

### CROSS-REFERENCE TO RELATED PATENT APPLICATIONS

This application claims the benefit of U.S. Provisional Patent Application No. 61/864,418 filed on Aug. 9, 2013, entitled MULTI-CURRENCY FINANCIAL CONSOLIDATION, the disclosure of which is hereby incorporated herein in its entirety by this reference.

### FIELD OF THE INVENTION

The present invention is directed to systems and methods for producing consolidated financial statements from multiple ledgers, including ledgers having different currencies, in accordance with various accounting rules.

### DESCRIPTION OF THE PRIOR ART

Single company business enterprises may have multiple accounting entities. In single company enterprises where divisions of responsibility result in more than one person interacting with accounting entries and reporting, the risk of changes to accounts in prior periods, accidental or otherwise, is increased, leading to productivity lost to reconciliations and changes to accounts and/or reporting.

Oh the other hand, multi-company business enterprises are structured as complex enterprises which may include various affiliates, for example, one or more subsidiaries. In the case of a multinational enterprise, the subsidiaries may include foreign subsidiaries operating in different currencies. Consequently, consolidated statements are needed, which typically requires multiple persons interacting with accounting entries and reporting involving multiple currencies. Again, the risk of changes to accounts in prior periods, accidental or otherwise, is increased, leading to productivity lost to reconciliations and changes to accounts and/or reporting.

A substantial number of enterprises, both single and multi-company, use QuickBooks™ available from Intuit, Inc. of Mountain View, Calif. for accounting purposes. However, the productivity of QuickBooks™ enterprise users is limited, because spreadsheets are typically the only means of performing multi-company multi-currency accounting consolidations.

### SUMMARY OF THE INVENTION

A non-limiting example in accordance with the present invention provides a system comprising a cloud based Software as a Service (SaaS) platform configured to operate as an application that integrates with QuickBooks™ through the Intuit Partner Platform (IPP), an open platform that enables developers to integrate with rich financial and transactional data through REpresentational State Transfer (REST)-based Application Programming Interfaces (APIs) or through the use of QuickBooks™ Web-Connector. In accordance with the non-limiting example, the system is targeted primarily at enterprises and professional accounting service providers who use QuickBooks™ and desire more advanced features around consolidated financial reporting and control over accounting data, which features are currently not available either on the QuickBooks™ platform, by way of an exclusive add-on, or as a third-party application.

A further non-limiting example in accordance with the present invention provides a method to enable enterprises with multiple accounting entities (including foreign currency based subsidiaries) to extract and consolidate accounting data from each subsidiary company. The subsidiary accounts are consolidated and posted to a separate parent company where the user is able to leverage all the reporting and other functionality that exists within QuickBooks™.

The system and method in accordance with the various examples of the present invention have several key features that help users automate and control the period end accounting consolidation process. By way of additional non-limiting examples, these features include the following.

By way of one non-limiting example, the system and method in accordance with the present invention provide an accounting entity structure map. As part of the initial setup, users must define the accounting entity structure of the business enterprise. The system and method allow users to easily define and set up their accounting entities using a hierarchical visual tree diagram that displays all subsidiary and parent companies linked together. Key information for each company such as account name, account type, and category is easily viewable in the same workspace, which avoids hidden menus or obscure configuration settings. Other companies may be added to the hierarchy as the business enterprise grows.

By way of another non-limiting example, the system and method in accordance with the present invention provide chart-of-account management. As part of the initial setup and on-going maintenance, users link each subsidiary account to a consolidation parent company account. The system and method allow users to see each subsidiary and parent company chart of accounts as a side-by-side list so users can easily visualize the entire chart-of-accounts structure and link each subsidiary account to a specific parent company account. This permits each subsidiary to maintain a unique chart of accounts with clear alignment to a consolidation level chart of accounts. After this initial setup, if new accounts are added in a subsidiary, the consolidation prime will receive notification prior to the consolidation process that the charts of accounts are not synchronized. The missing account is highlighted to the prime by identifying the sub-entity that added the new account and which account was added. The consolidation prime may then easily access the mapping setup screen and map the unmapped account. This functionality maintains the account mapping synchronized between the consolidation company and the sub-entities.

By way of an additional non-limiting example, the system and method in accordance with the present invention provide foreign currency rate management. A critical component of consolidating foreign subsidiaries is management of foreign exchange rates. The system and method allow users to easily input required foreign exchange rates such as month end, month average, and historical rates. Rates for each period are stored and easily viewed in a table format for reference and audit control.

By way of a further non-limiting example, the system and method in accordance with the present invention provide click-control consolidation. Once the initial setup requirements have been completed (a one-time event) and all accounts are mapped, users can initiate a period consolidation of subsidiary companies with a single click. Before actual posting of the consolidated accounts, the system and method present, for each subsidiary, a summary of account balances in both the source currency and translated reporting currency. After review of the accounts, actual posting of the consolidated accounts to the parent company is a simple one-click procedure. After this initial setup, if new accounts are added in a subsidiary, the consolidation prime will receive notification prior to the consolidation process that the charts of accounts are not synchronized. The missing account is highlighted to the prime by identifying the sub-entity that added the new account and which account was added. The consolidation prime may then easily access the mapping setup screen and map the unmapped account. This functionality maintains the account mapping synchronized between the consolidation company and the sub-entities.

By way of a still further non-limiting example, the system and method in accordance with the present invention provide that consolidated accounts post into a separate QuickBooks™ company. As part of the original setup, the system and method create a separate QuickBooks™ company for each consolidation or parent company. Consolidated accounts are posted to this separate company. Capturing consolidated accounts in a separate QuickBooks™ company allows users to leverage all of the reporting, audit, and other functionalities that exist within the QuickBooks™ platform, exclusive add-ons, and third-party applications.

By way of an additional non-limiting example, the system and method in accordance with the present invention provide prior period accounting entry control. A useful control feature included in the system and method is the visibility and control over journal entries, direct or via sub-ledgers, posted to periods that have been previously consolidated and closed. The system and method are configured to sweep in all transactions in a subsidiary company, regardless of the actual period being consolidated. The system and method compare the sweep to previous sweeps, and a notification will be generated to alert users of any new accounting entries posted to the subsidiary accounts. The system and method provide the user control over whether to accept the entry and post it to the consolidated accounts or reject the entry. All postings to the consolidated company are date-stamped for audit control.

By way of yet another non-limiting example, the system and method in accordance with the present invention provide accounting data backup to enable backup storage of accounting data. A prior period accounting entry notification feature stores a copy of all accounting transactions from each subsidiary company. This provides users with an alternate source to backup critical accounting data.

While the core application of the system and method in accordance with the various examples of the present invention appeals to business enterprises that consolidate multiple accounting entities for multi-company enterprises, there are several key features that provide significant value to single company enterprises, as well. Currently, for example, in single company enterprises where divisions of responsibility result in more than one person interacting with accounting entries and reporting, the risk of changes to accounts in prior periods, accidental or otherwise, is increased, leading to productivity lost to reconciliations and changes to accounts and/or reporting. Advantageously, single company enterprises may use the system and method in accordance with the present invention to effectively create a separate set of books that serves as a set of closed financial for reporting purposes. The prior period accounting entry control feature provides a clear alert to changes in prior period(s) and provides actionable control over unexpected changes.

In summary, the system and method in accordance with the various examples of the present invention significantly improve the productivity of QuickBooks™ enterprise users where spreadsheets are currently the only means of performing multi-entity accounting consolidations. In addition, the creation of a separate closed set of books and the inherent controls over changes to prior period accounting data have wide application to both single company and multi-company enterprises.

### BRIEF DESCRIPTION OF THE DRAWING

The various examples of the present invention will be described in conjunction with the accompanying figures of the drawing to facilitate an understanding of the present invention. In the figures, like reference numerals refer to like elements. In the drawing:

FIG. 1 illustrates a consolidation organizational structure according to one example of the present invention.

FIG. 1A illustrates notifications regarding a consolidation organizational structure according to one example of the present invention.

FIGS. 2-2B illustrate a company setup according to an example of the present invention.

FIG. 3 illustrates a company setup pop-up screen in accordance with an example of the present invention.

FIG. 4 is a flow diagram of a company setup method in accordance with an example of the present invention.

FIG. 5 is a flow diagram of a method for initiating a mapping between two different, companies in accordance with an example of the present invention.

FIG. 6 depicts a JavaScript Object Notation (JSON) object which may be used to display a company object's data according to an example of the present invention.

FIGS. 7 and 7A illustrate a method for mapping company accounts and classes in accordance with an example of the present invention.

FIGS. 8-13 are flow diagrams of a method for mapping accounts in accordance with an example of the present invention.

FIG. 14 depicts a JSON object for a single source account in accordance with an example of the present invention.

FIG. 15 shows an example destination account JSON object in accordance with an example of the present invention.

FIGS. 16 and 17 depict an example of transaction data in a trial balance format.

FIGS. 18A-B illustrate an example of a summary trial balance.

FIG. 19 shows the rate table maintained by month by currency in conjunction with a consolidation method in accordance with an example of the present invention.

FIG. 20 is a flow diagram of a transfer or download method in accordance with an example of the present invention.

FIG. 21 is a flow diagram of a consolidation method in accordance with an example of the present invention.

FIGS. 22A-C illustrate an example of a Consolidated Profit and Loss Statement.

FIGS. 23A-B depict an example of a Consolidated Balance Sheet.

FIG. 24 illustrates an example of a Consolidated Statement of Cash Flow.

FIG. 25 is a block diagram of an example of a computing system that may be used to implement the examples of the systems and methods in accordance with the present invention.

### DETAILED DESCRIPTION OF THE PREFERRED EXAMPLES

Examples of the system and method in accordance with the present invention may include one or more of a setup process, mapping process, consolidation process, and reporting process.

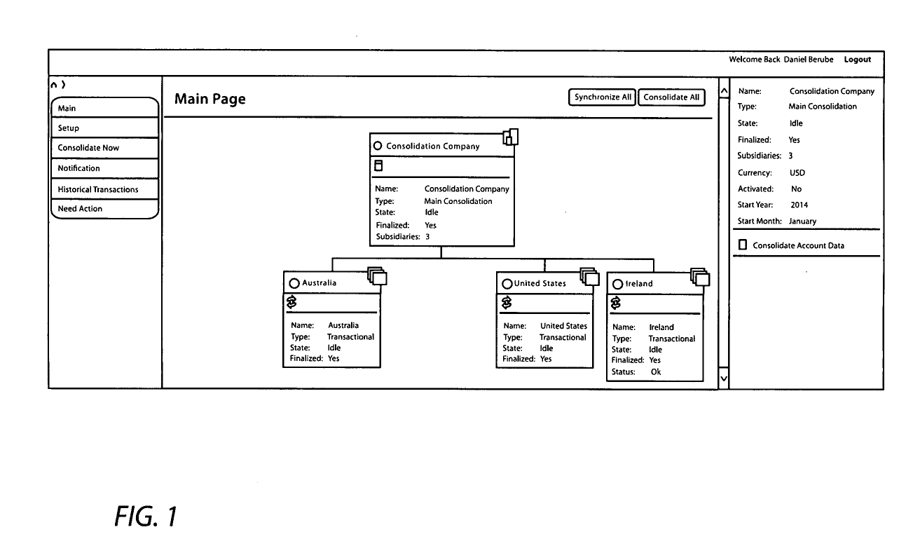

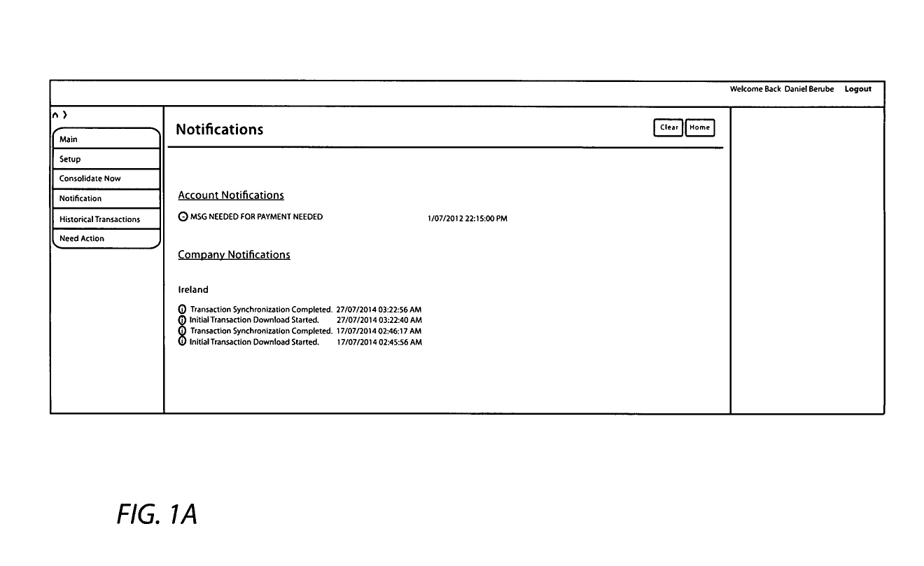

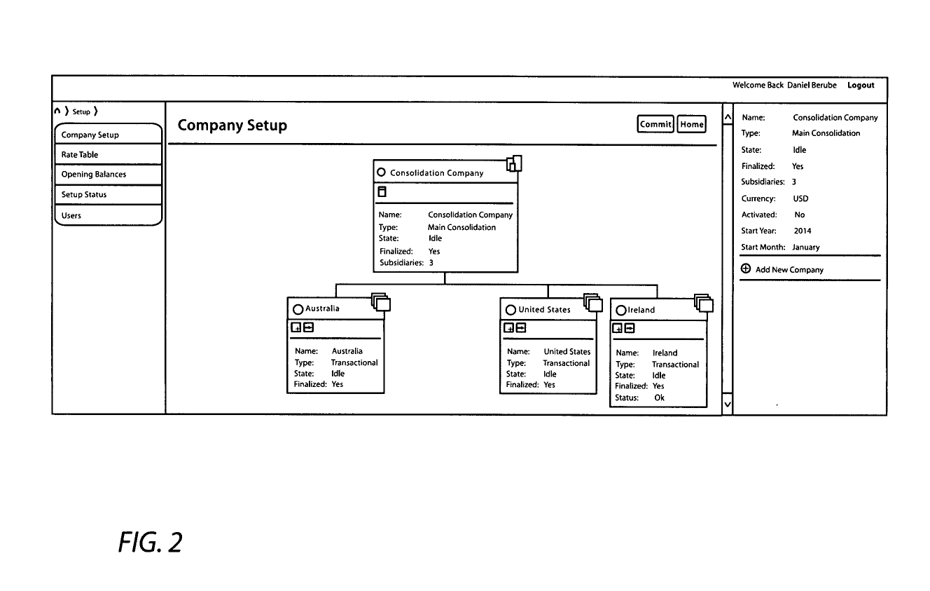

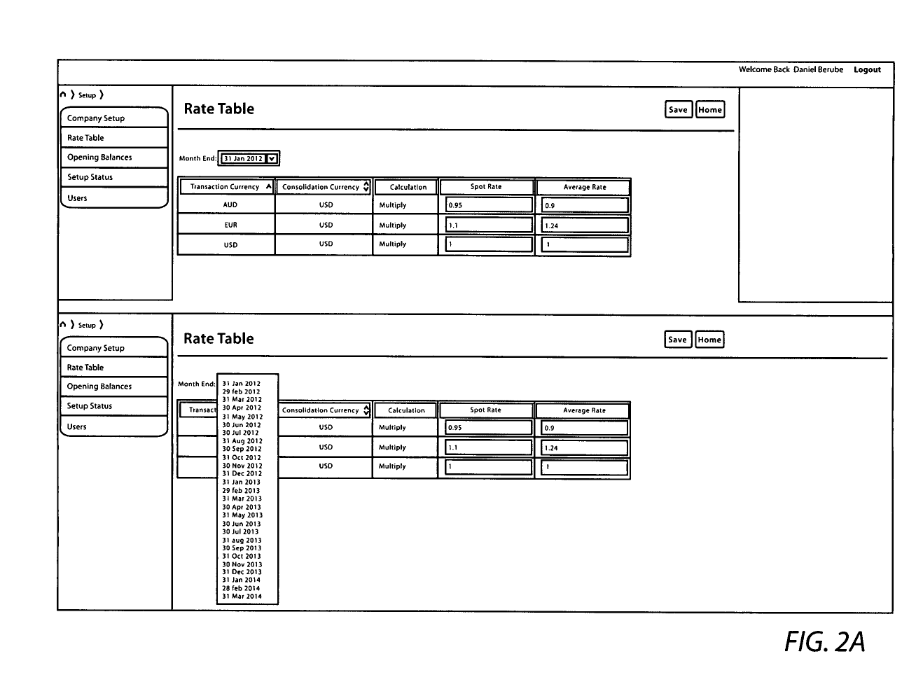

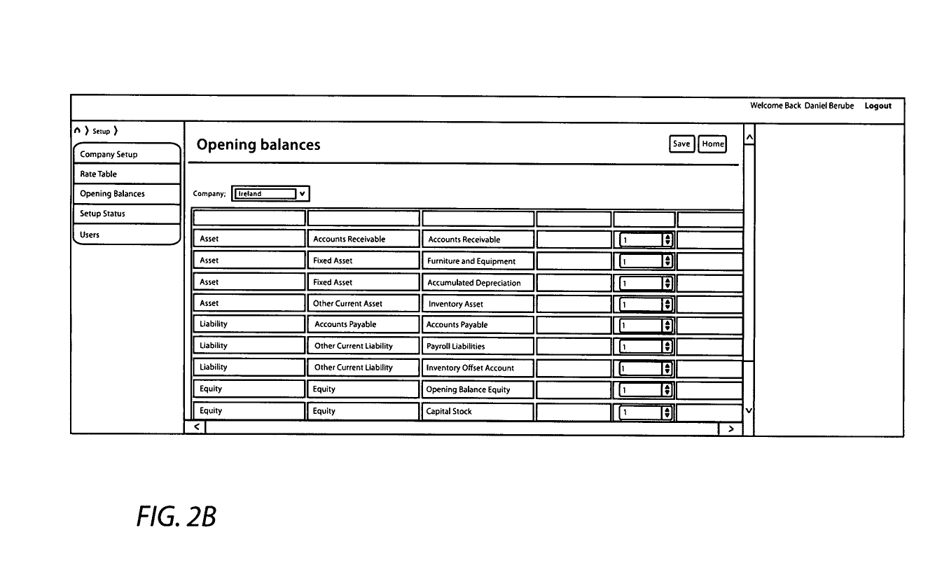

Generally, by way of a non-limiting example, during the setup process, a user may create a representation of a consolidation organizational structure after companies have been mapped, as will be described below. FIG. 1 illustrates a consolidation organizational structure according to an example of the present invention. Menu options may be provided to a user, for example, as shown along the left-hand side of FIG. 1. FIG. 1 illustrates a Main Page having a menu option “Setup” along the left-hand side which the user selects to initiate a Company Setup as shown in FIG. 2. Another menu option along the left-hand side of FIG. 1 which the user may select is “Notification.” As shown in FIG. 1A, user selection of “Notification” causes the system to compare a sweep to previous sweeps, and a notification will be generated to alert users of any new accounting entries posted to the subsidiary accounts.

FIG. 2 illustrates a Company Setup page. Account setup may include mapping and aligning a chart of accounts between entities and consolidation companies. As shown in FIG. 2, menu options for Company Setup along the left-hand side include, for example: “Company Setup,” “Rate Table,” “Opening Balance,” “Setup Status,” and “Users.” Companies Setup specifies one or more companies that may be consolidated. Setup Status guides, tracks, and records the steps to completing the setup for each entity.

FIG. 2A illustrates a Rate Table page which may include entering, importing (i.e., received as a file), updating, etc., currency exchange rates that may be applied to different accounts or transactions from various specified companies. The Rate Table enables exchange rates to be stored and made available for the consolidation. As shown in FIG. 2A, exchange rates are stored by type (e.g., Euro, US Dollar, etc.) and by month.

FIG. 2B illustrates an “Opening Balance Rates” page to provide a one-time setup for loading the opening balance for a company, captured by company by Balance Sheet Account. Blended exchange rates are also captured to provide the correct opening balance.

Additionally, an “Account Data” page may be provided to track a user account. A “Users” page may also be provided for setting up and storing user data.

Details of a company in the consolidation organizational structure may be presented to the user. FIG. 2, for example, may display details (e.g., on the right-hand side) for a company on the consolidation organizational structure in response to selection by a user. Company details may, for example, comprise: Name, Type, Subsidiaries,Currency, status of being Activated, Start Year, and Start Month, for the selected company. Name of the company may be the name of the company selected by the user (and optionally highlighted in the consolidation organizational chart). Type may include indicia of whether the selected company is a transactional company or a consolidation company. Subsidiaries may include how many subsidiaries are rolled up into the consolidation company. Currency may include the main functional currency of the selected company. Activated may include “Yes” (e.g., the selected company has been created in an accounting package and modified transactions may be pushed across) and “No” (e.g., the selected company is not created in the accounting package and may not receive modified transactions).

In accordance with examples of the Company Setup, a financial reporting structure and/or a tax structure may be created and/or configured. In the consolidation organizational structure shown in FIG. 2, for example, the organization of companies in the consolidation organizational structure may be changed, for example, by dragging and dropping one or more blocks. In this way, a consolidation organizational structure may be defined/edited and reviewed by a user.

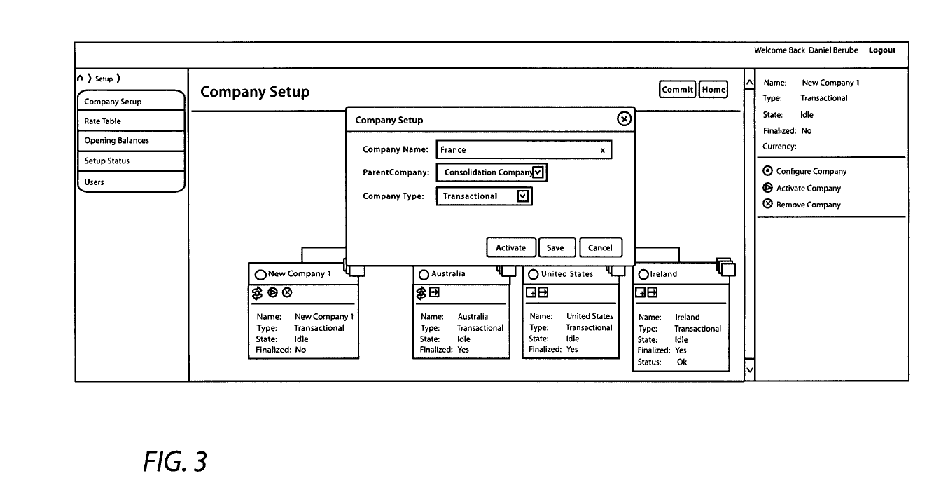

FIG. 3 depicts a company setup pop-up screen in accordance with an example of the present invention. For example, a user may identify companies that may be part of a consolidation process. The pop-up screen may comprise: Company Name, Parent Company, Company Type, Method, and Subsidiaries. Company Name may be the name of the created or selected company. Parent Company may identify a relationship between the created or selected company and another company with which the created or selected company will consolidate (e.g., a parent/child relationship may be mapped). Company Type may include Transactional and Consolidation. Method may be a consolidation method to be applied (e.g., current or temporal). Subsidiaries may indicate how many companies will roll up to the company that is being created as a consolidation company. The organizational chart can be modified by dragging and dropping, in accordance with various examples in accordance with the present invention, the organizational chart may be finalized and locked.

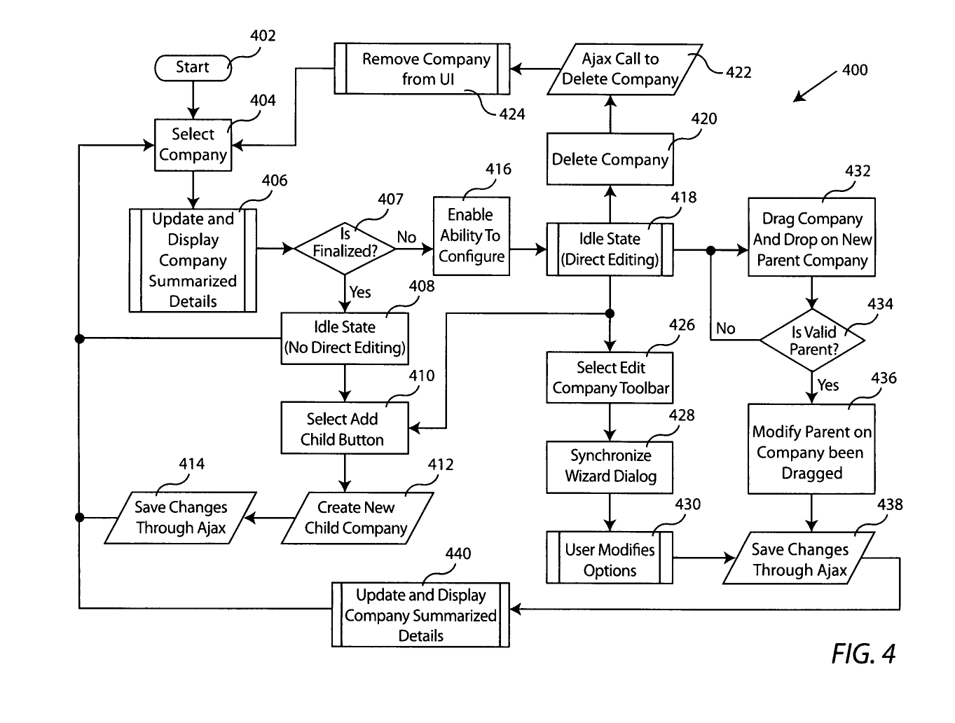

FIG. 4 is a flow diagram of a method for company setup in accordance with an example of the present invention. Company setup may include one or more of the following steps.

As shown in FIG. 4, the company setup method 400 begins at Start, as indicated by a step 402. In response to receiving indicia of selection of a company by a user, as indicated by a step 404, company information (e.g., summarized in the right-hand pane of FIG. 2) is displayed, as indicated by a step 406. A determination is then made whether or not the selected company is finalized, as indicated by a step 407. If the selected company is finalized, as indicated by the “Yes” branch from the decision block indicated by numeral 407, and the system is in the idle state, as indicated by a step 408, then the user will only be able to add new child companies associated to the selected company, as indicated by steps 410, 412, and 414, and operation returns to 404. If the selected company is not finalized, as indicated by the “No” branch from the decision block indicated by the numeral 407, the user will be able to configure the selected company, as indicated by a step 416. If the system is in the idle state, as indicated by a step 418, then the user may add one or more child companies, as indicated by the steps 410, 412, and 414. On the other hand, the user may delete/remove the selected company and all its children, as indicated by steps 420, 422, and 424. Also, the user may optionally edit information respecting the selected company, as indicated by steps 426, 428, and 430. The user may also change the selected, company's parent (e.g., by dragging the company and dropping it onto another company, or by editing the options to change the parent), as indicated by steps 432, 434, and 436. After being configured, a company may, for example, be updated on a server in response to the user selecting the next company or using a wizard to move to the next company. In response to the user providing indicia that the present company setup session is completed (e.g., by selecting a Commit/Cancel button at the top of the page shown in FIG. 2), current configurations may be saved, and any companies and all new companies may be finalized, as indicated by steps 438 and 440. In this way, the user may return at a later time or move to a different machine/browser to continue to work on the organizational chart representation.

In accordance with some examples, a wizard may be provided for one or more of the foregoing company setup process steps, as indicated by the step 428. A software wizard (or setup assistant) may be a user interface that presents the user with a sequence of dialog boxes that lead the user through a series of steps to implement the company setup process.

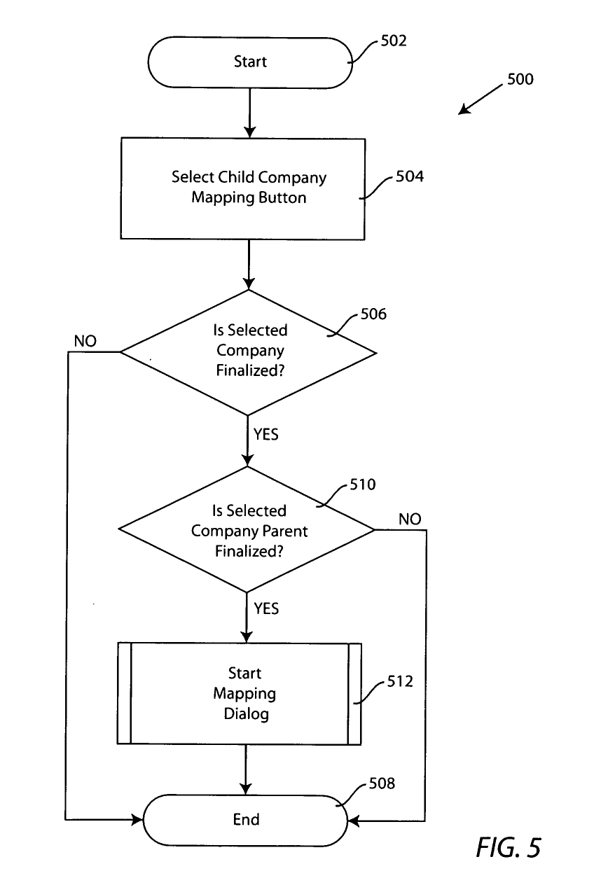

FIG. 5 is a flow diagram of a method for mapping between two different companies in accordance with an example of the present invention. Mapping between two different companies may include the following steps.

As shown in FIG. 5, the company mapping method 500 begins at Start, as indicated by a step 502, and continues in response to selection (e.g., from a user) indicating a child company to map to another company, as indicated by a step 504. A determination is made whether or not the selected company has been finalized, as indicated by a step 506. If the selected company is not finalized, as indicated by the “No” branch from the decision block indicated by numeral 506, the company mapping ends, as indicated by a step 508. If the selected company is finalized, as indicated by the “Yes” branch from the decision block indicated by numeral 506, then a determination is made whether the selection is associated with one or more finalized companies and/or companies whose parents are finalized, as indicated by a step 510. If at least both the above conditions apply, as indicated by the “Yes” branch from the decision block indicated by numeral 510, then a mapping dialog may be provided to the user, as indicated by a step 512. The mapping dialog may receive one or more inputs from the user which may be used to map the selected company to the parent company. Then, company mapping ends, as indicated by the step 508. Alternatively, if the parent company is not finalized, as indicated by the “No” branch from the decision block indicated by numeral 510, the company mapping ends, as indicated by the step 508.

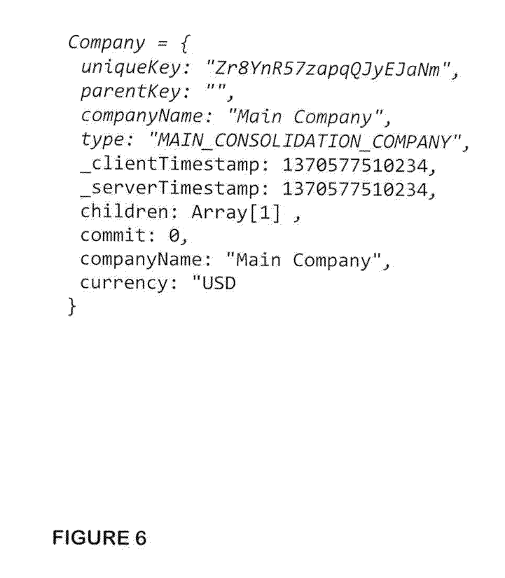

FIG. 6 depicts a JavaScript Object Notation (JSON) object which may be used to display a company object's data according to an example of the present invention. JSON is a text-based standard designed for human-readable data interchange. As shown in FIG. 6, properties of the JSON object may include: Parent Key, Company Name, Type, Client Timestamp, Server stamp, Children, Commit, and Currency. Parent Key may be a unique key to designate the parent company. Company Name may be a display name that identifies the company. Type may be the Company Type. Client Timestamp and Server Timestamp may be used to track changes made to the company object data and may be used to determine if the server needs to be updated. In one example, the Client Timestamp may only be modified (e.g., via a web browser interface) when changes are made to the company (optionally) whether the company is finalized or not. Children may indicate an array of companies that are children of the company. In some examples, the array of child companies may be the same as or similar to the object of FIG. 6. Commit may, for example, be “1” (e.g., when the company has been finalized) and “0” (e.g., when the company has not been finalized). Currency may indicate a working currency of the company.

As part of the company setup process, an opening balance may be uploaded or calculated for the start period of consolidation, as will be described in more detail below. A user may determine or define the consolidation start period for a company. The consolidation start period determines the starting point of the consolidation process.

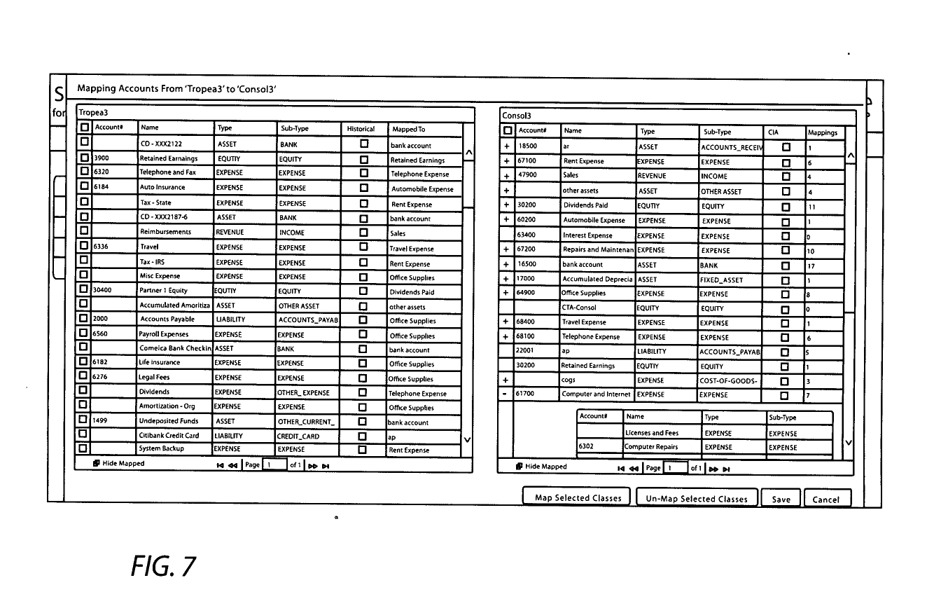

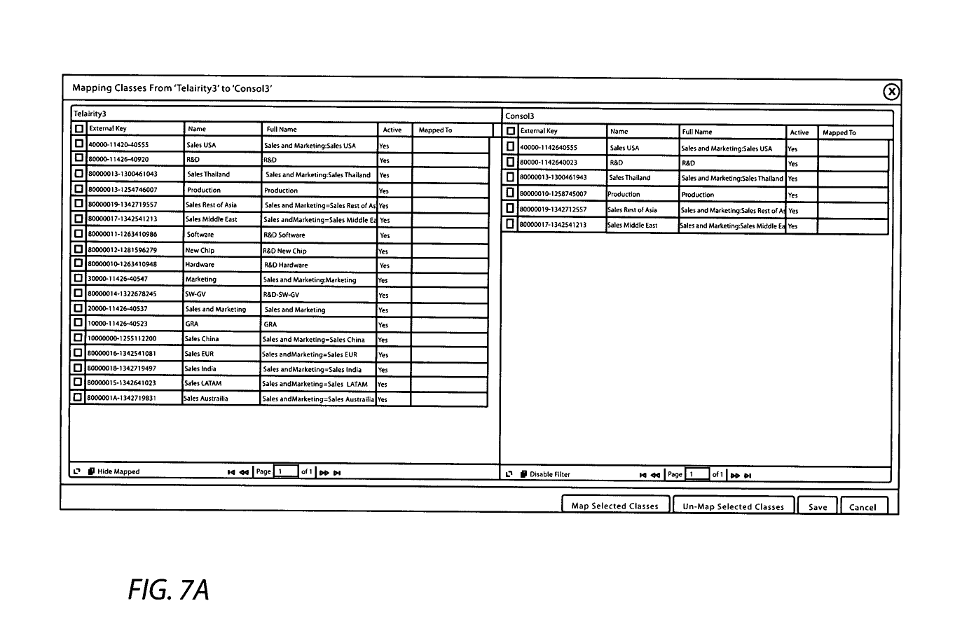

FIG. 7 illustrates company account mapping according to a non-limiting example of the present invention. Once a structure is set up (and locked in), a next step may be to map the Chart of Accounts (COA) and cost centers from one subsidiary company to the consolidation company. In accordance with one example, the COA of both companies may, for example, pop up on the page, and a user may, for example, drag and drop one or more accounts from a subsidiary/transactional company to a consolidation company. This may be done in a visual manner (e.g., graphically on a display). Optionally, as each account is mapped, the account no longer appears on the screen. Accordingly, a user may be provided with the accounts that have been mapped and those that need mapping, for example, in a visual manner such as graphically on a display. In addition, the mapping of the accounts may identify historical accounts (e.g., accounts that do not need to be revalued), a currency translation account (e.g., where the exchange rate impact is booked), and elimination accounts (e.g., to allow for intercompany transactions to be handled). In accordance with one example, the company account mapping process and the identification of the different types of accounts may be initiated based on receiving indicia from a user, such as clicking in a box. Company account mapping, for example, may be performed during setup, and then the mapped data may be stored. As shown in FIG. 7A, classes/departments may also be mapped between sub transactional/consolidation companies.

By way of a further non-limiting example in accordance with the present invention, prior to the consolidation process for each period, a database/transactional scan may compare loaded data to data associated with the sub transactional/consolidation companies. If a difference is detected, then an alert identifying the variance may be provided. For example, in response to accounts being added after the setup, an alert identifying the changes to the COA may be provided. The setup may be modified for the changed accounts without changes to the historical accounts. If a mapping is performed incorrectly, then the mapping may be performed again (and updated) after the consolidation.

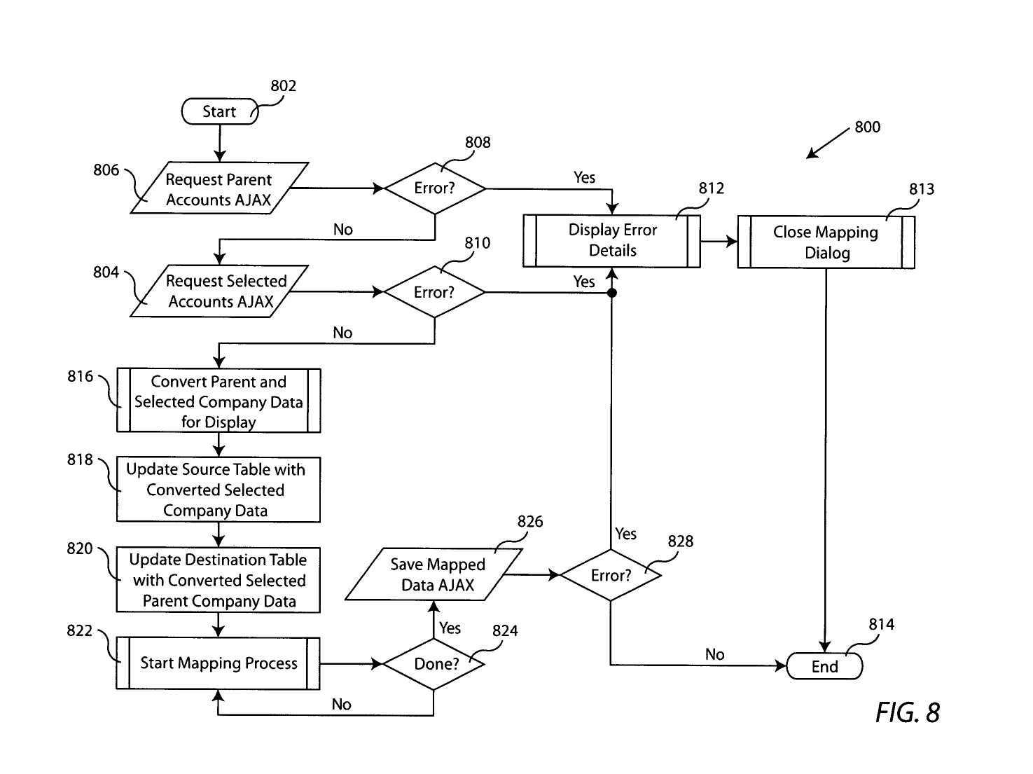

FIG. 8 is a flow diagram of a non-limiting example of an initialization phase of a company account mapping dialog and may additionally include a commit/save step. The initialization phase of a company account mapping dialog may include the following steps.

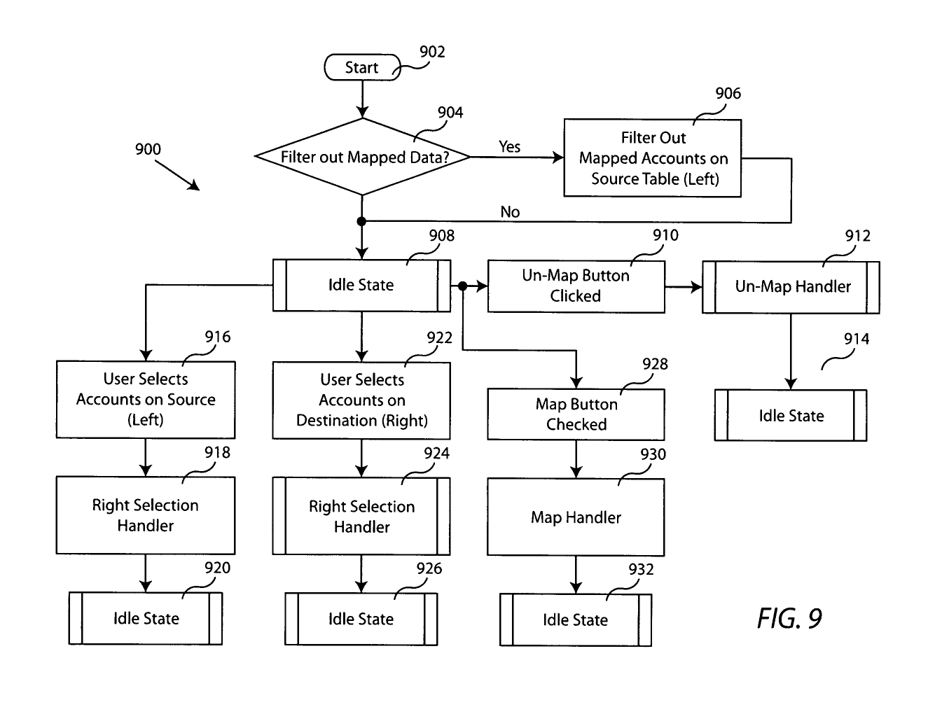

As shown in FIG. 8, the initialization phase of a company account mapping dialog 800 begins at Start, as indicated by a step 802. The system requests (e.g., from a server) accounts for both the child company selected by the user (e.g., at the step 504 in FIG. 5) and companies associated with the parent company (e.g., at the step 510 in FIG. 5), as indicated by steps 804 and 806, respectively. If any error is detected respecting the account data, as indicated by the “Yes” branch from a decision block 808 or 810, respectively, error details are displayed, as indicated by a step 812, the company mapping dialog is closed, as indicated by a step 813, and the company account mapping dialog ends, as indicated by a step 814. If no error is detected respecting the account data, as indicated by the “No” branch from the decision blocks indicated by numerals 808 and 810, the account data for the selected child company and the parent company received from the server is converted for display to the user, as indicated by a step 816. Conversion (e.g., for display) may include: flattening a tree structure, for example, into a list array; updating each source company object, which has been mapped, to reflect a destination account identification (ID), as indicated by a step 818; and/or updating each destination company, to which accounts are mapped, with an array of source account IDs (e.g., many-to-one mapping), as indicated by a step 820. Optionally, urn-mapped accounts (e.g., denoted by the Start Mapping Process block, indicated by a step 822) are identified to the user. A user may optionally provide inputs for mapping the un-mapped accounts, for example, as will be described later in conjunction with FIG. 9. A determination is made whether or not the mapping process is complete, as indicated by a step 824. If the mapping process is not complete, as indicated by the “No” branch from the decision block indicated by the numeral 824, the account mapping process, indicated by the step 822, continues. If the account mapping process is complete, as indicated by the “Yes” branch from the decision block indicated by the numeral 824, mapped data is saved, as indicated by a step 826, and a determination is made whether or not an error has occurred, as indicated by a step 828. If any error is detected respecting the mapped data, as indicated by the “Yes” branch from the decision block indicated by the numeral 828, error details are displayed, as indicated by the step 812, the company account mapping dialog is closed, as indicated by the step 813, and the company account mapping dialog ends, as indicated by the step 814. If no error is detected respecting the mapped data, as indicated by the “No” branch from the decision block indicated by the numeral 828, the company account mapping dialog ends, as indicated by the step 814. In accordance with a further non-limiting example, the company account mapping method may enable saving or cancelling changes after accounts have been mapped and/or un-mapped, based, for example, on indicia received from a user.

FIGS. 9-13 are flow diagrams of a method for mapping accounts in accordance with examples of the present invention. In accordance with one example of the account mapping method, multiple selections by the user may be allowed. These selections may include, for example: filtering accounts on the destination table based at least in part on account types (this filter may be enabled or disabled); providing and/or enabling an un-map account (e.g., undo) button, in response to selected accounts being mapped; and optionally receiving from the user indicia that the un-map button has been selected, depressed, clicked, activated, or the like. The method for mapping accounts may include the following steps.

As shown in FIG. 9, the method for mapping accounts 900 begins at Start, as indicated by a step 902. A determination is made whether or not a user selects to filter out mapped account data, as indicated by a step 904. If the user has selected to filter out mapped account data, as indicated by the “Yes” branch from the decision block indicated by the numeral 904, the system filters out (e.g., removes) all mapped accounts from a source table (e.g., left table), as indicated by a step 906. If the system is in the idle state, as indicated by a step 908, this filter may be turned on and off, for example, to allow the user to un-map mapped accounts, as indicated by a step 910. whereupon the system un-maps mapped accounts, as indicated by a step 912, and the system then returns to the idle state, as indicated by a step 914.

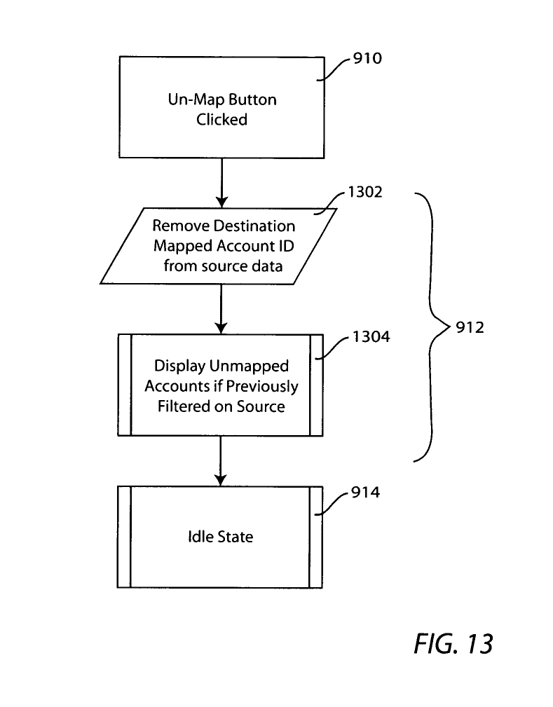

The steps 910, 912, and 914 are shown in more detail in FIG. 13. As shown in FIG. 13, the system un-maps the selected accounts, responsive at least in part to receiving from the user indicia that the un-map accounts button has been selected, depressed, clicked, activated, or the like, as indicated by the step 910. Next, the system updates the account objects on the source by at least removing the destination account ID from the Mapped To property, as indicated by a step 1302. Then, the system updates the destination objects, to which these accounts were previously mapped, by at least removing the source account ID from the Mapped To property array, as indicated by a step 1304. Thereafter, the system returns to the idle state, as indicated by the step 914.

Referring again to FIG. 9, if the user does not select to filter out mapped account data, as indicated by the “No” branch from the decision block indicated by the numeral 904, or after the system filters out all mapped accounts from a source table (e.g., left table), as indicated by the step 906, and the system is idle, as indicated by the step 908, the user may select one or more accounts on the source table, as indicated by a step 916, whereupon the system processes the selected account(s), as indicated by a step 918, and the system then returns to the idle state, as indicated by a step 920.

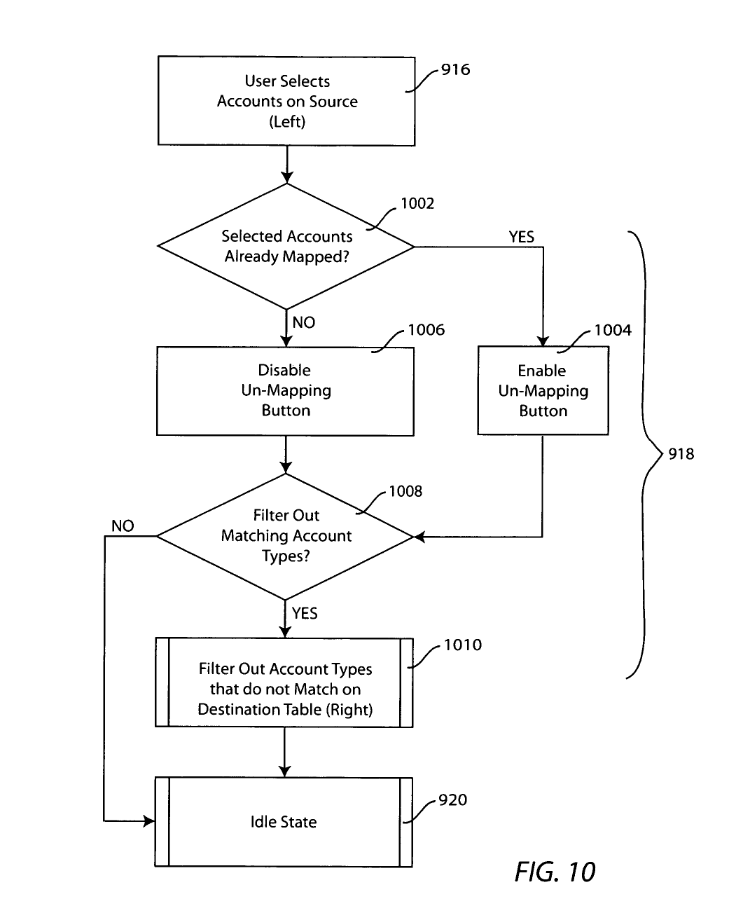

The steps 916, 918, and 920 are shown in more detail in FIG. 10. As shown in FIG. 10, after the user selects one or more accounts on the source table, as indicated by the step 916, a determination is made whether or not the selected account(s) is already mapped, as indicated by a step 1002. If the account is already mapped, as indicated by the “Yes” branch from the decision block indicated by the numeral 1002, the un-mapping button is enabled for selection by the user, as indicated by a step 1004. If the account is not already mapped, as indicated by the “No” branch from the decision block indicated by the numeral 1002, the un-mapping button is disabled for selection by the user, as indicated by a step 1006. Whether or not the un-mapping button is enabled at the step 1004 or disabled at the step 1006, a determination is made whether or not to filter out matching account types, as indicated by a step 1008. If the matching account types are to be filtered out, as indicated by the “Yes” branch from the decision block indicated by the numeral 1008, the system filters out account types that do not match account types on the destination table, as indicated by a step 1010, and the system returns to the idle state, as indicated by the step 920. If the matching account types are not to be filtered out, as indicated by the “No” branch from the decision block indicated by the numeral 1008, the system returns to the idle state, as indicated by the step 920.

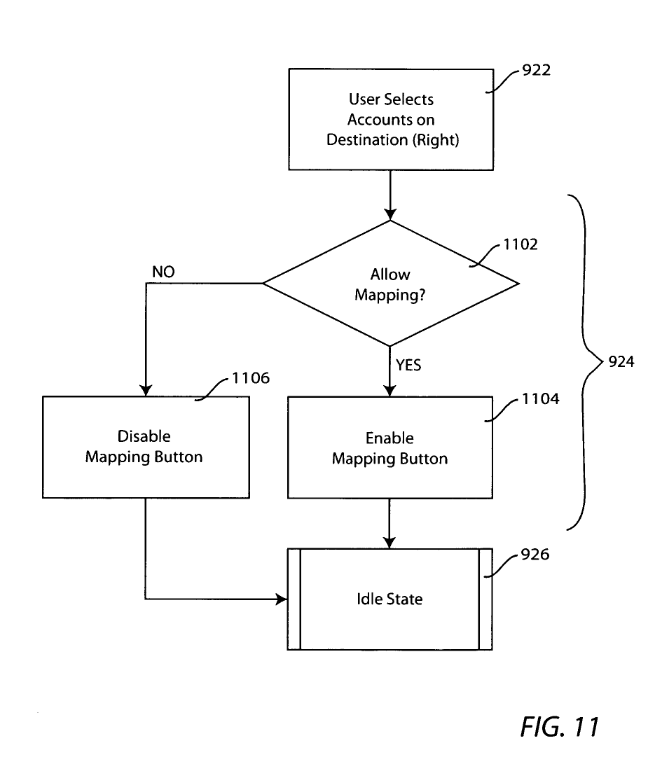

Referring once again to FIG. 9, the user may select one or more accounts on the destination table (e.g., right table), as indicated by a step 922, whereupon the system processes the selected account(s), as indicated by a step 924, and the system then returns to the idle state, as indicated by a step 926. The steps 922, 924, and 926 are shown in more detail in FIG. 11.

As shown in FIG. 11, after the user selects one or more accounts on the destination table, as indicated by the step 922, a determination is made whether or not to allow mapping the selected account(s), as indicated by a step 1102. If mapping is allowed, as indicated by the “Yes” branch from the decision block indicated by the numeral 1102, the mapping button is enabled for selection by the user, as indicated by a step 1104. If mapping is not allowed, as indicated by the “No” branch from the decision block indicated by the numeral 1102, the mapping button is disabled for selection by the user, as indicated by a step 1106. Whether or not the mapping button is enabled at the step 1104 or disabled at the step 1106, the system then returns to the idle state, as indicated by the step 926. Thus, accounts may be mapped, for example, based at least in part on the user selecting an account on the destination table. In one non-limiting example, only a single selection may be allowed.

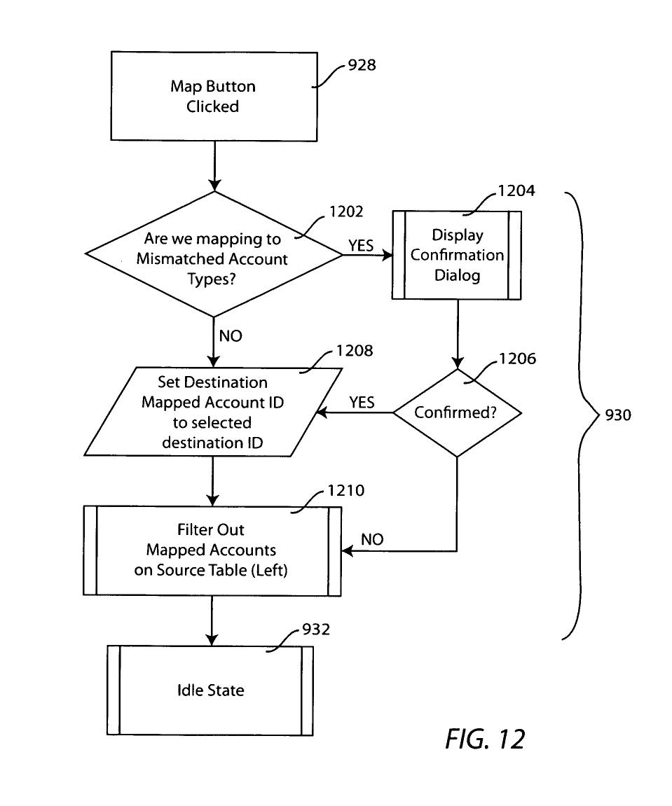

Referring yet again to FIG. 9, the user may select (e.g., click) the map button, as indicated by a step 928, whereupon the system maps the selected account(s), as indicated by a step 930, and the system then returns to the idle state, as indicated by a step 932. The steps 928, 930, and 932 are shown in more detail in FIG. 12.

As shown in FIG. 12, after the user selects the map button, as indicated by the step 928, a determination is made whether or not mapping of account(s) is to mismatched account types, as indicated by a step 1202. If mapping would be to mismatched account types, as indicated by the “Yes” branch from the decision block indicated by the numeral 1202, a confirmation dialog is displayed to the user, as indicated by a step 1204, whereupon a determination is made whether or not mapping between mismatched account types is confirmed by the user, as indicated by a step 1206. If mapping would be not be between mismatched account types, as indicated by the “No” branch from the decision block indicated by the numeral 1202, or mapping between mismatched account types is confirmed by the user, as indicated by the “Yes” branch from the decision block indicated by the numeral 1206, the system sets the destination mapped account ID to the selected destination ID, as indicated by a step 1208, whereupon the system filters out mapped accounts on the source table, as indicated by a step 1210, and the system then returns to the idle state, as indicated by the step 932. If the mapping between mismatched account types is not confirmed by the user, as indicated by the “No” branch from the decision block indicated by the numeral 1206, the system filters out mapped accounts on the source table, as indicated by the step 1210, and the system then returns to the idle state, as indicated by the step 932.

In summary, mapping accounts may be based at least in part on receiving indicia from the user, for example, enabled by user selection of the map accounts button or other control. Mapping the accounts may be responsive at least in part to the user selecting the map accounts button. Mapping accounts may involve updating the Mapped To property for each source account with at least the destination account ID. If the account was previously mapped to a different account, then the account may first be un-mapped and then mapped to the new account. Updating the target destination account array may be achieved by at least adding the source account ID. The user may be provided a confirmation dialog when the account type of the source account does not match the account type on the destination account. The mapped account may be removed from the source table if the filter has been enabled after the account is mapped.

In a further non-limiting example of the method in accordance with the present invention, the Cumulative Translation Adjustment (CTA), historical, and elimination options on the target destination account may be modified when the user interface is modified (not depicted in FIGS. 9-13). In accordance with one example, only one target destination account may have its CTA checked, so if the user selects CTA checking for a specific account, then all other accounts have their CTA unselected (e.g., set to “0”). This method offers the benefits of quickly mapping accounts and over time reducing what is displayed as an indicator of outstanding work.

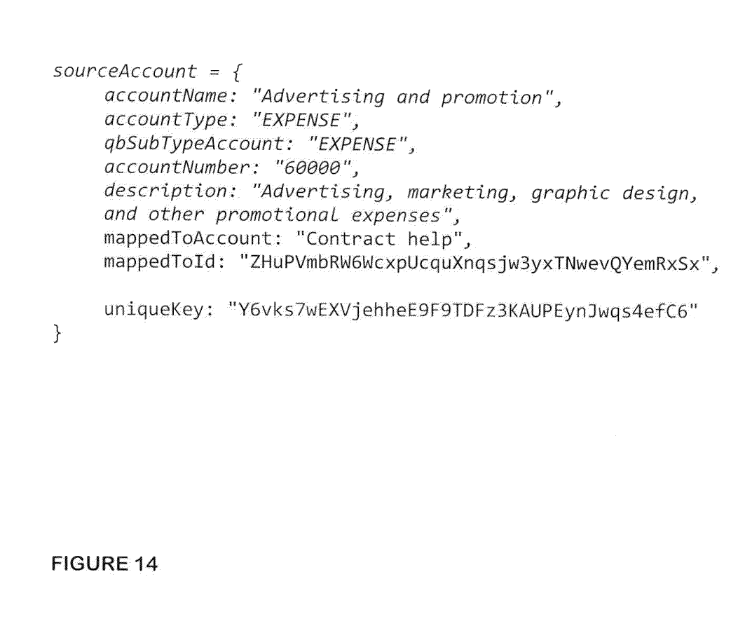

FIG. 14 illustrates an example source (e.g., selected account) JSON object for a single source account. As shown in FIG. 14, the JSON object for a single account may have one or more of the following properties:
Account Name—The account name may be a defined name associated with an account.
Account Type—The account type may be used to filter the destination account table.
Sub Account Type—A sub account type may be used for display purposes within the account mapping dialog.
Account Number—An account number may be associated to the account.
Description—A description may be used for display purposes and may be defined by the user, for example, when the user creates one or more accounts.
Mapped To Account—The Mapped To account may be a name of a target destination account to which the selected account may be mapped, may be used for display purposes, or may be “empty” (e.g., if the selected account is un-mapped).
Mapped To ID—The Mapped To ID may be a unique ID of the target destination account or may be “empty” for un-mapped accounts. The Mapped To ID may be used when saving changes to the server.
Unique Key—The unique key may be generated by the server when accounts are imported from an external source and may be used during the account mapping process.

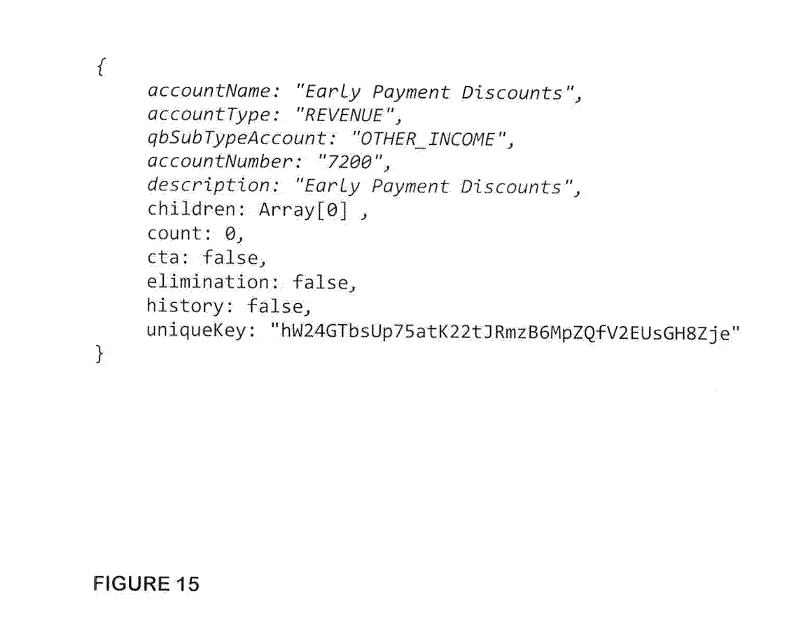

FIG. 15 shows an example destination account JSON object. The destination account JSON object may have the following properties, which were not described above in relation to the source JSON object:
Children—Children identifies all source accounts that may not have been mapped to the destination account.
Count—Count is a property that may reflect the child count and may be used for display purposes.
CTA, Elimination, and History—These may be Boolean options which may be set, for example, when the user selects checkboxes in the target destination list.

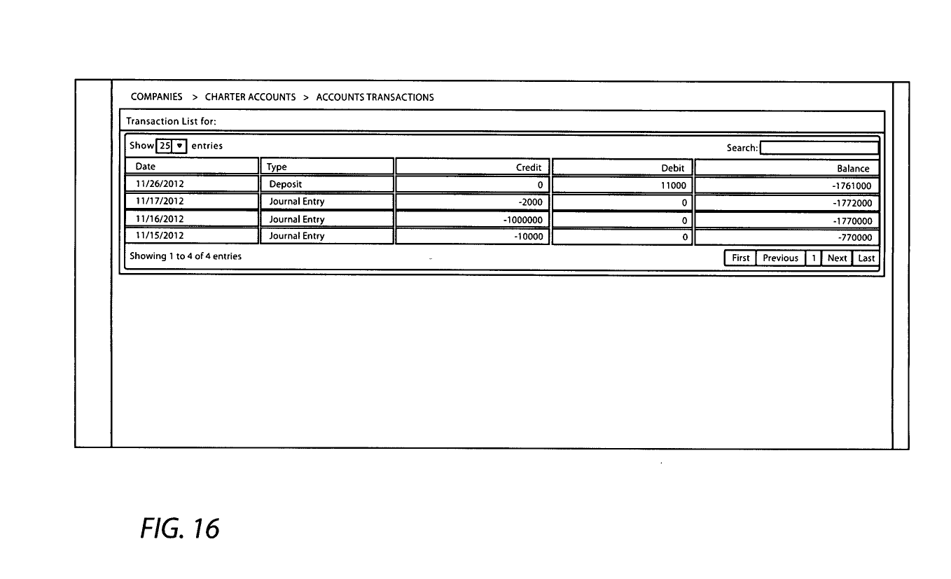

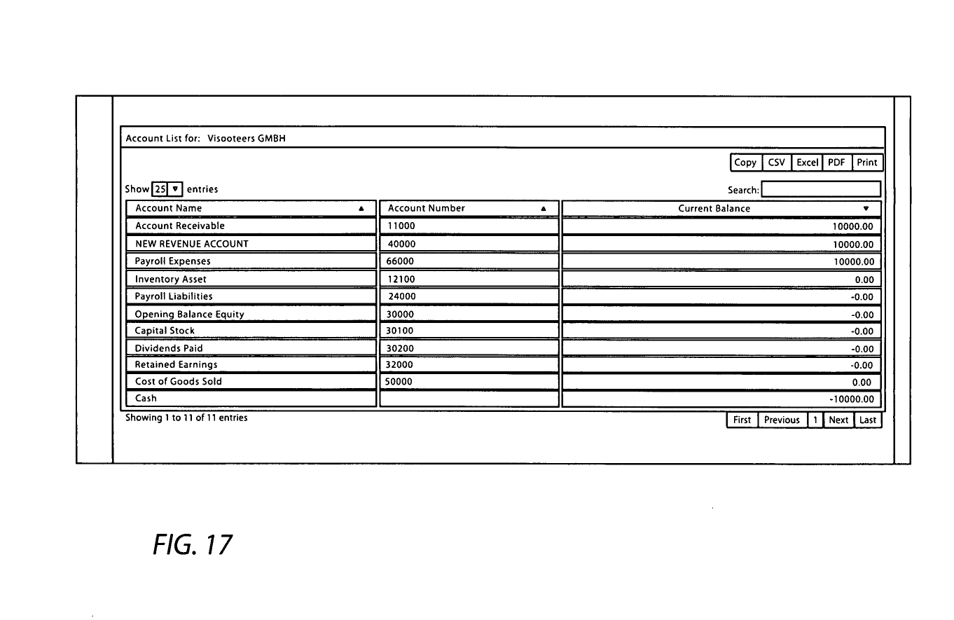

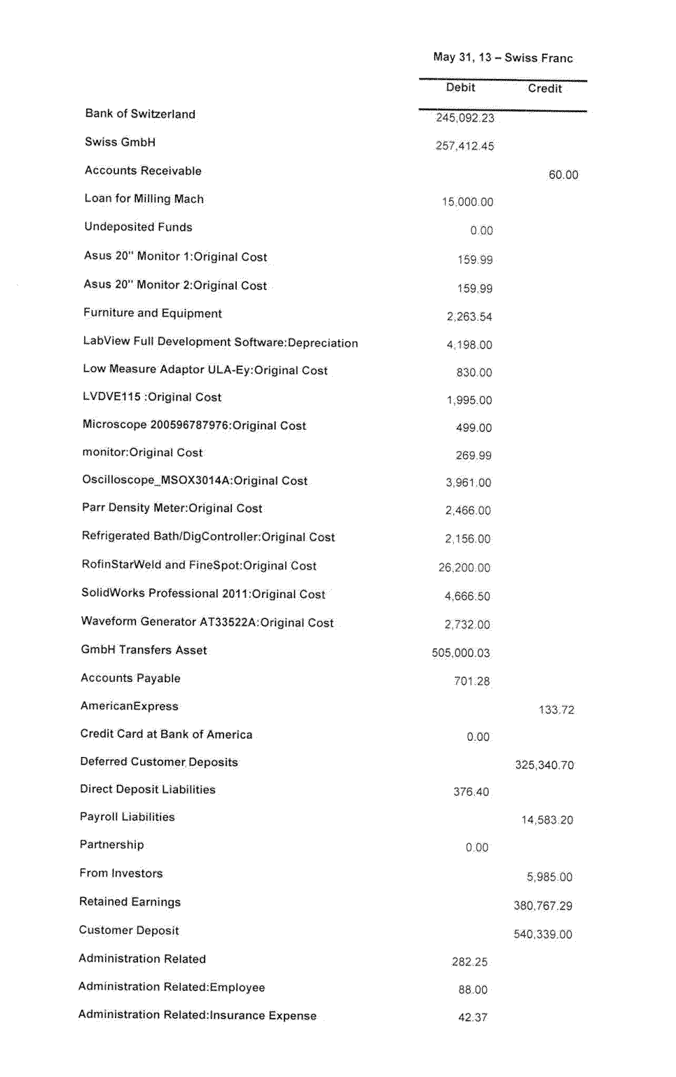

In accordance with various examples of the system and method of the present invention, once inputs are received from the user, transaction information may be imported (e.g., from third-party accounting software), accounting rules may be applied, and the transformed information may be stored and/or provided to the consolidation company. Imported transaction data, for example, may be in a trial balance format. FIGS. 16 and 17 depict an example of transaction data in the trial balance format.

Imported transaction data may include detailed transactions that may complete a trial balance by company. Various examples of the method in accordance with the present invention may use at least a trial balance in one currency to be converted into another currency. A trial balance may be a list of all the general ledger accounts (both revenue and capital) contained in the ledger of a business enterprise. This list may include the name of the nominal ledger account and the value of that nominal ledger account. The value of the nominal ledger may hold a debit balance value or a credit balance value. The debit balance value may be listed in the debit column of the trial balance, and the credit value balance may be listed in the credit column.

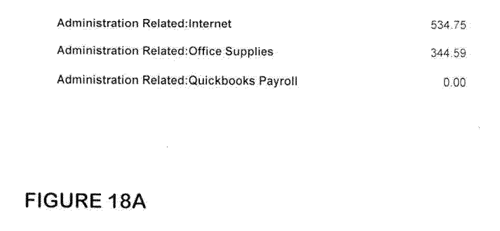

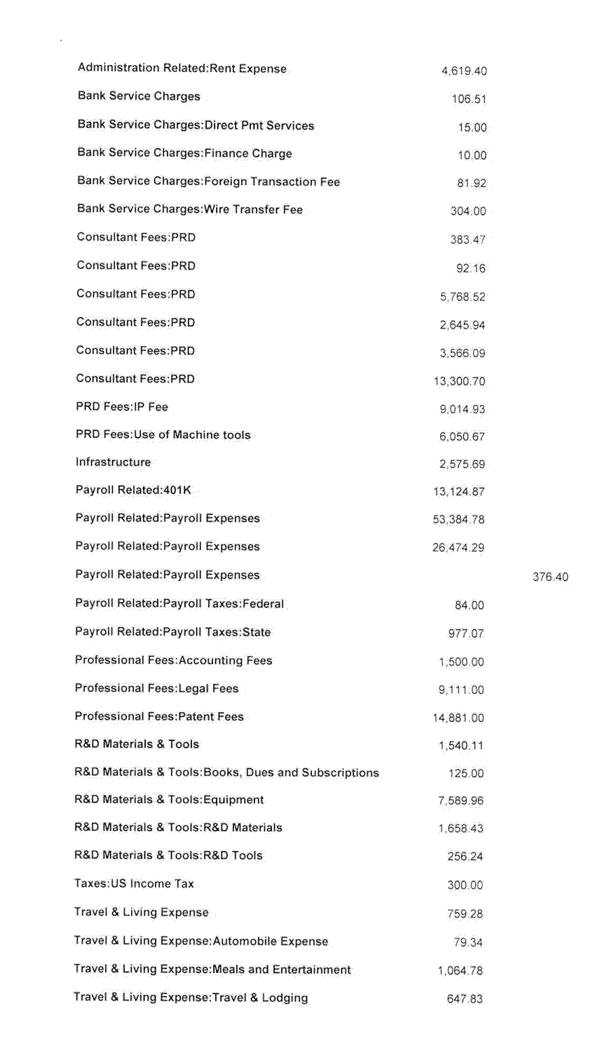

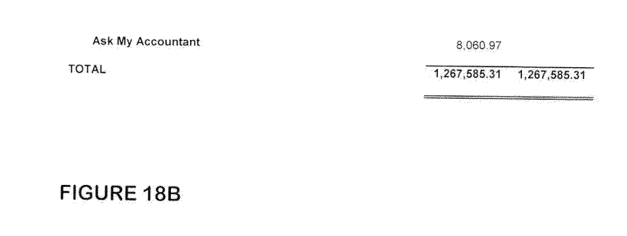

FIGS. 18A-B illustrate an example of a summary trial balance. Imported transaction data may be produced by or received from accounting software, such as QuickBooks™, Sage One, FreshBooks, Harvest, Free Agent, Zoho Books, LessAccounting, Peachtree, WorkingPoint, Xero, Kashoo, and the like, for example.

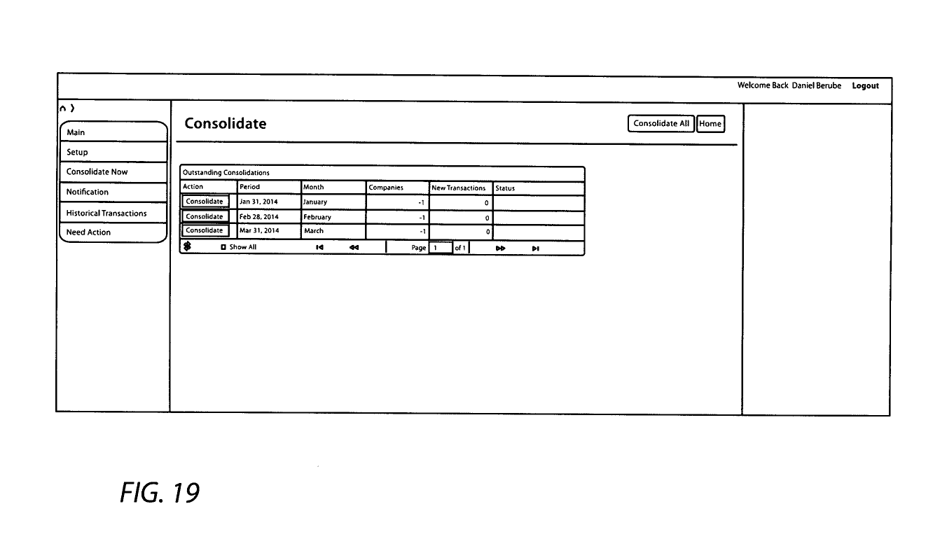

As previously described, FIG. 2A shows an example of a rate table. In accordance with one example of the system and method of the present invention, historical rates for average and month end rates may be captured and stored. These rates may be applied in response to a trigger based at least in part on mapping accounts, accounting rules (e.g., generally accepted accounting principles (GAAP), International Financial Reporting Standards (IFRS), and the like), and a ledger mapping setup, to appropriate transactions. Converted transactions may be pushed to the consolidation company. FIG. 19 shows a Consolidate page generated by a consolidation method in accordance with an example of the present invention, which will be described in detail below, after the transaction data is transferred or downloaded, as will now be described.

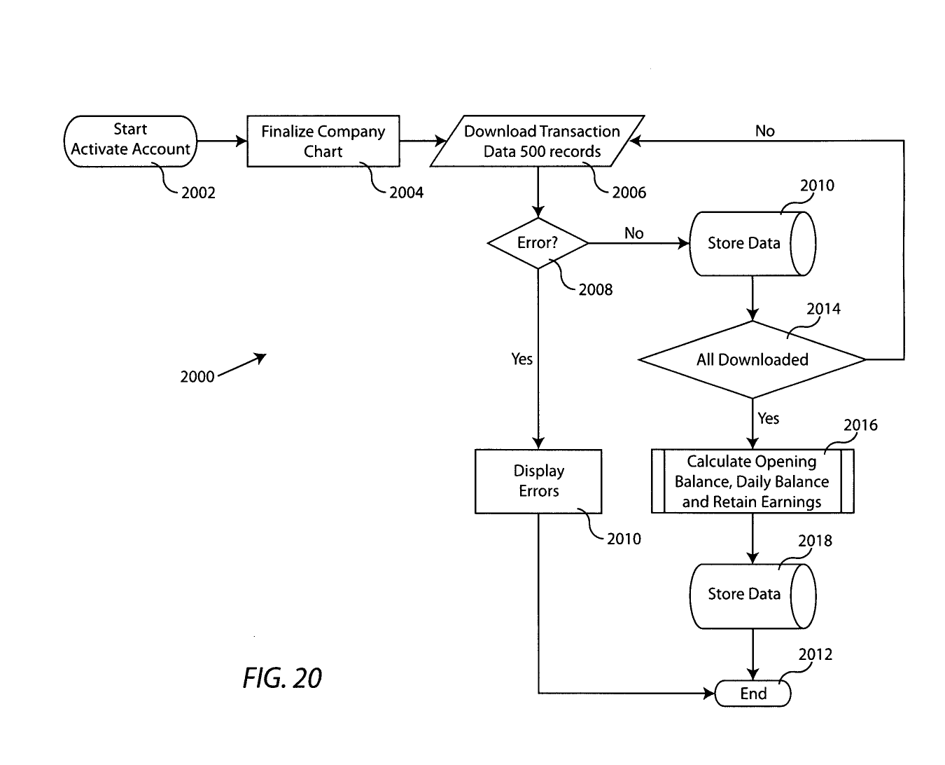

FIG. 20 is a flow diagram of a transaction transfer or download method in accordance with a further non-limiting example in accordance with the present invention preparatory to consolidation. The transfer or download method may include one or more of the following steps.

As shown in FIG. 20, the transaction transfer or download method 2000 may be conditioned upon one or more of the companies having been activated, as indicated by a step 2002, and the company organizational chart having been finalized, as indicated by a step 2004. Then, the system may download some or all the transactions for some or all the companies, as indicated by a step 2006. The transaction data for each company may be downloaded one at a time. Transaction data may be downloaded in blocks (e.g., of 500 records). A determination is made whether or not there are any errors in the downloaded data, as indicated by a step 2008. If no download errors are detected, as indicated by the “No” branch from the decision block indicated by the numeral 2008, each block of records may be stored in a database, as indicated by a step 2010. If download errors are detected, as indicated by the “Yes” branch from the decision block indicated by the numeral 2008, the system displays the errors, as indicated by a step 2010, and the download ends, as indicated by a step 2012. A determination is made whether or not all transaction data has been downloaded, as indicated by a step 2014. If additional transaction data needs to be downloaded, as indicated by the “No” branch from the decision block indicated by the numeral 2014, the system continues to download and store transaction data, as indicated by the steps 2006, 2008, and 2010. If all transaction data has been downloaded and stored, as indicated by the “Yes” branch from the decision block indicated by the numeral 2014, the Opening Balance, Daily Balances, and Retain Earnings may be calculated by the system, as indicated by a step 2016. The system may store the calculated Opening Balance, Daily Balances, and Retain Earnings in a database, as indicated by a step 2018, whereupon the transaction download method ends, as indicted by the step 2012.

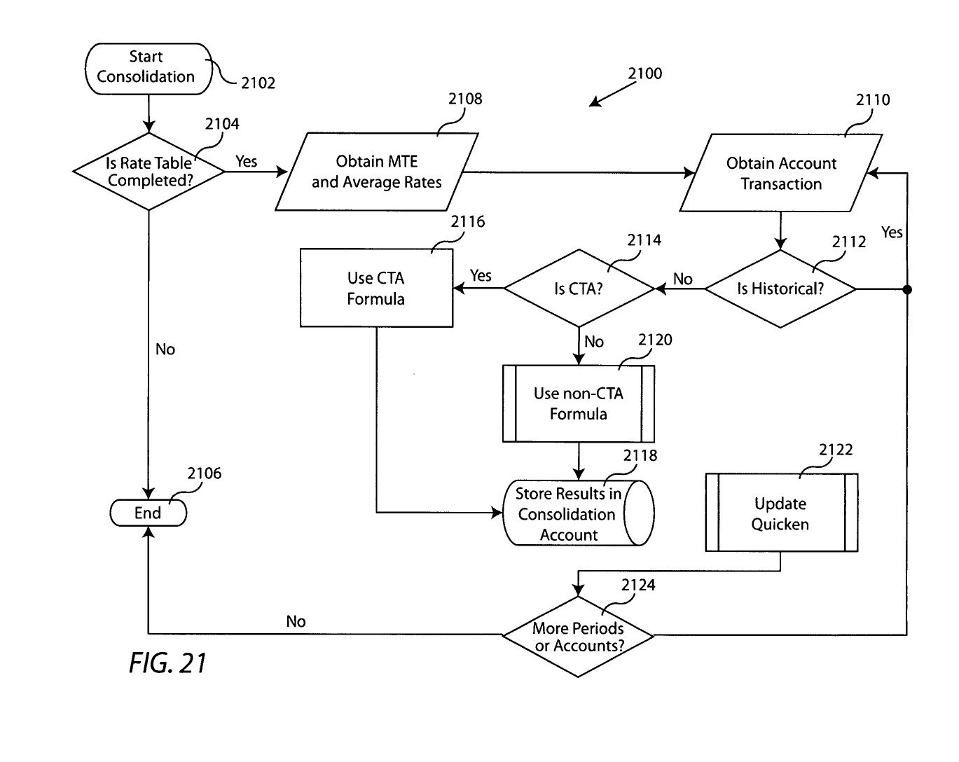

FIG. 21 is a flow diagram of a consolidation method in accordance with an example of the present invention. In accordance with various examples of the present invention, the consolidation method may be conditioned upon one or more of the user having activated companies and the user having finalized the company organizational chart. The consolidation method may include one or more of the following steps.

As shown in FIG. 21, the consolidation method 2100 begins at Start Consolidation, as indicated by a step 2102. A determination is made whether or not the rate table has been completed, as indicated by a step 2104. The consolidation may only be performed for a period if the user has defined the rates. If the rate table is incomplete, as indicated by the “No” branch from the decision block indicated by the numeral 2104, the consolidation method ends, as indicated by a step 2106. If the rate table is complete, as indicated by the “Yes” branch from the decision block indicated by the numeral 2104, the system obtains the applicable rates from the rate table, as indicated by a step 2108. Then, the system may start to download account transactions, as indicated by a step 2110. A determination is made whether or not historical transactions are to be consolidated, as indicated by a step 2112. Historical accounts may be not be processed. If historical transactions are to be included in the consolidation, as indicated by the “Yes” branch from the decision block indicated by the numeral 2112, then the historical transaction data as well as current transaction data is obtained, as indicated by the step 2110. If historical transactions are not to be included in the consolidation, as indicated by the “No” branch from the decision block indicated by the numeral 2112, then only the current transaction data is obtained, as indicated by the step 2110. Next, a determination is made whether or not the account is a CTA account, as indicated by a step 2114. Consolidation applies one (e.g., of two) formulas based on whether the account is a CTA account or a non-CTA account. On the one hand, if the account is a CTA account, as indicated by the “Yes” branch from the decision block indicated by the numeral 2114, a CTA formula is applied, as indicated by a step 2116, and the results are stored in a consolidation account based on the account mappings, as indicated by a step 2118. On the other hand, if the account is not a CTA account, as indicated by the “No” branch from the decision block indicated by the numeral 2114, a non-CTA formula is applied, as indicated by a step 2120, and the results are stored in a consolidation account based on the account mappings, as indicated by a step 2118. The result stored in the consolidation account, as indicated by the step 2118, may then be provided (e.g., posted back) to accounting software (e.g., into the consolidation account), as indicated by a step 2122. A determination is then made whether additional accounting periods and/or accounts need to be consolidated, as indicated by a step 2124. If additional accounting periods and/or accounts need to be consolidated, as indicated by the “Yes” branch from the decision block indicated by the numeral 2124, then the method returns to the step 2110 to obtain additional transaction data to consolidate, and the consolidation method repeats steps 2112, etc., and consolidation moves to the next account and/or next period until all transactions have been downloaded. If there are no additional accounting periods and/or accounts to be consolidated, as indicated by the “No” branch from the decision block indicated by the numeral 2124, then the consolidation method ends, as indicated by the step 2106.

In accordance with other non-limiting examples of the method of the present invention, alerts (e.g., pop-up windows, screens, and the like) which highlight exceptions (e.g., changes to the chart of accounts (COA)), transactions booked to prior periods, missing exchange rates, and the like) may be provided. By way of a further non-limiting example in accordance with the present invention, reports may be generated. Alternatively or additionally, reporting tools provided by accounting software may be used to generate reports.

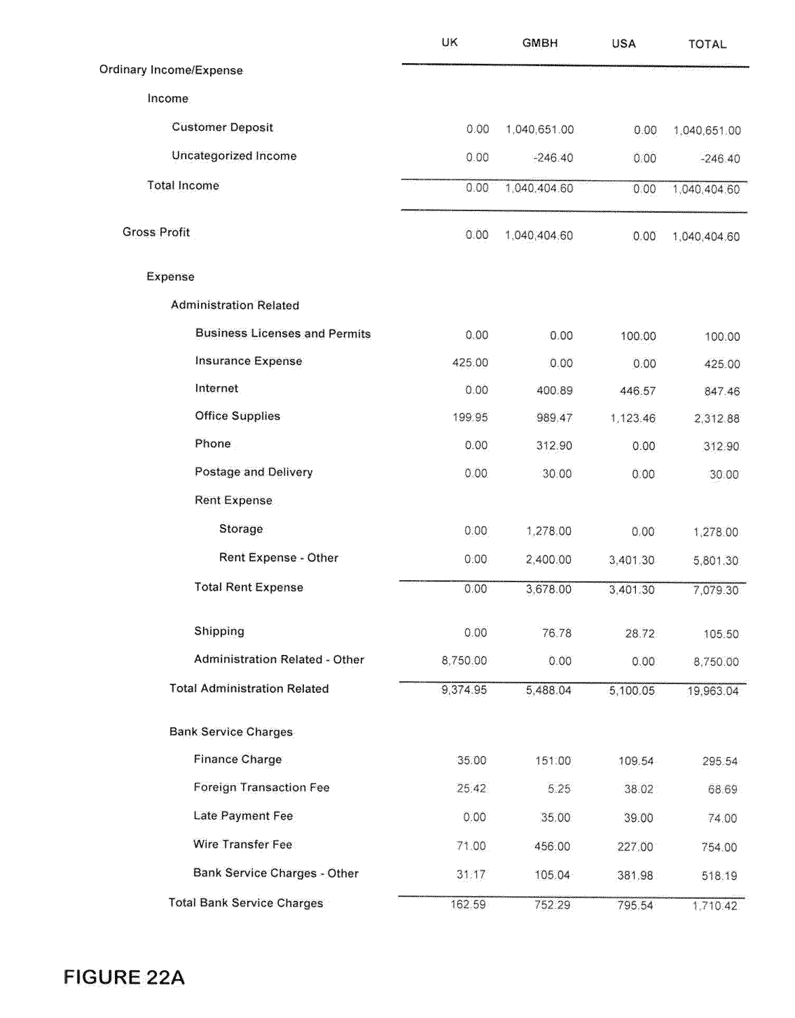

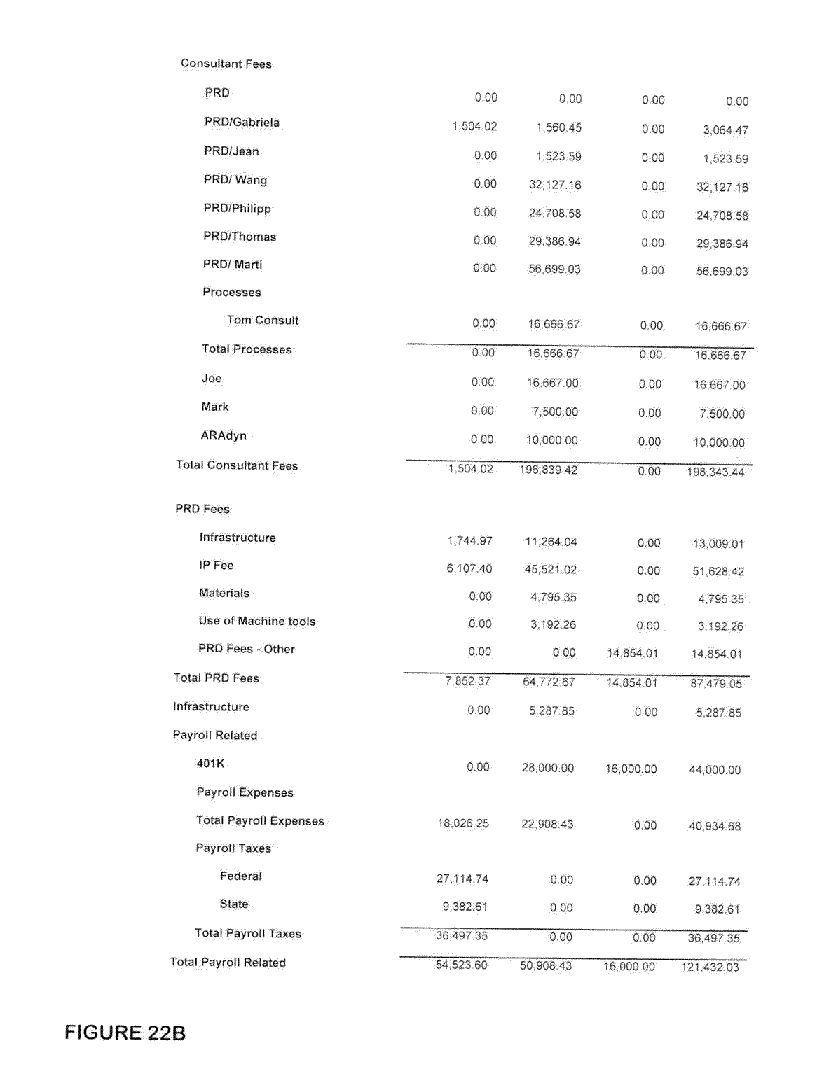

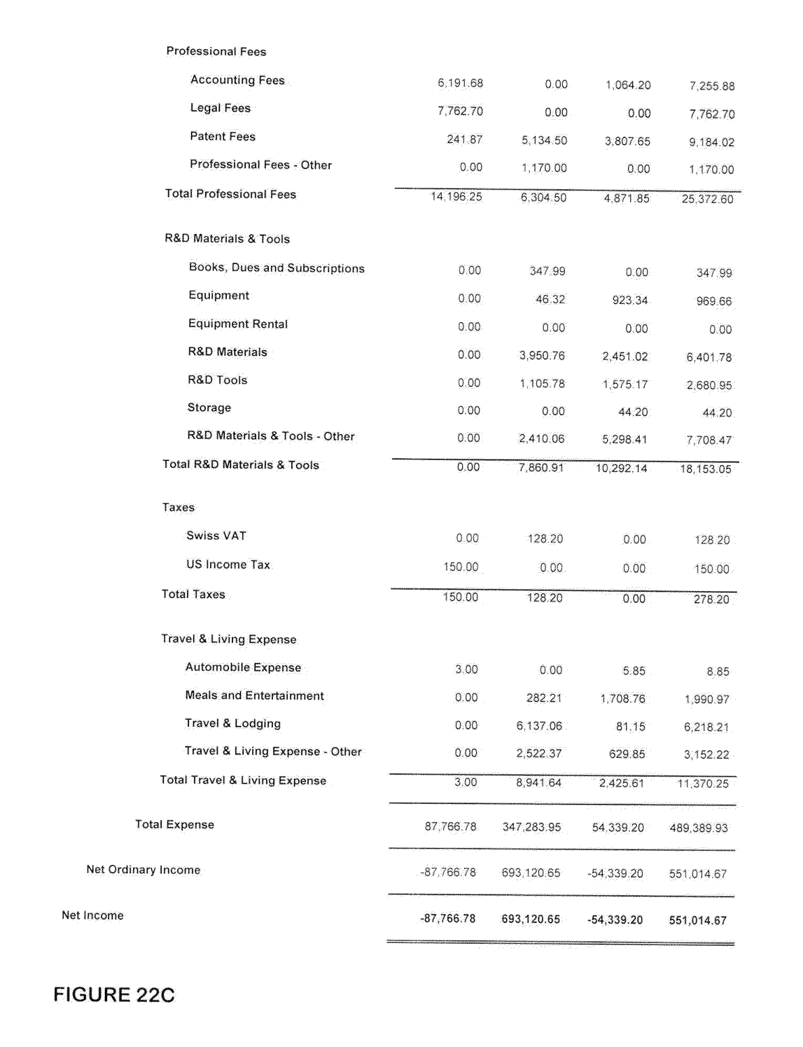

By way of example and not limitation, the system and method in accordance with the present invention may provide reports which may include one or more of a Consolidated Profit and Loss Statement, Consolidated Balance Sheet, and Consolidated Statement of Cash Flow. FIGS. 22A-C illustrate an example of a Consolidated Profit and Loss Statement.

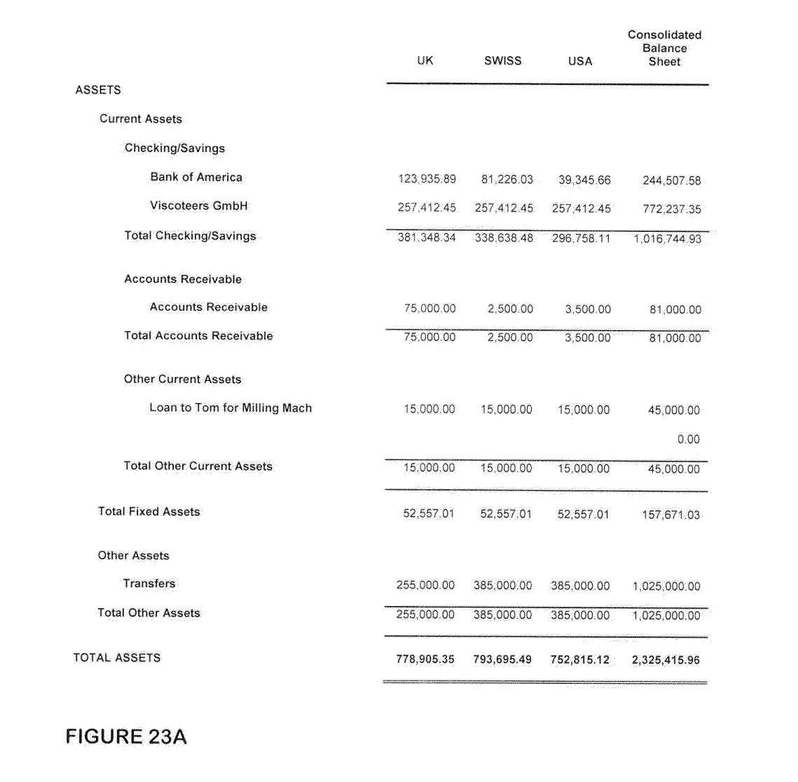

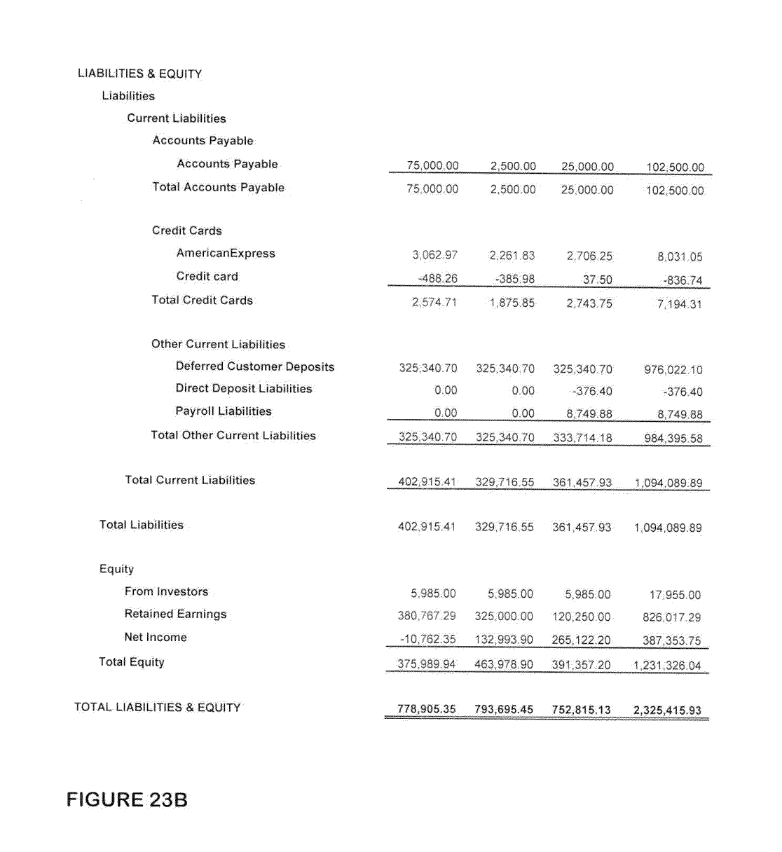

FIGS. 23A-B depict an example of a Consolidated Balance Sheet. In financial accounting, a balance sheet or statement of financial position may be a summary of the financial balances of a sole proprietorship, a business partnership, a corporation, or other business organization, such as an LLC or an LLP. Assets, liabilities, and ownership equity may be listed as of a specific date, such as the end of the company's financial year. A balance sheet may be described as a “snapshot of a company's financial condition.” A company balance sheet may include three parts: assets, liabilities, and ownership equity. The main categories of assets may, for example, be listed first and/or in order of liquidity. Assets may be followed by liabilities. A difference between the assets and the liabilities is known as equity or the net assets or the net worth or capital of the company, and according to an accounting equation, net worth must equal assets minus liabilities.

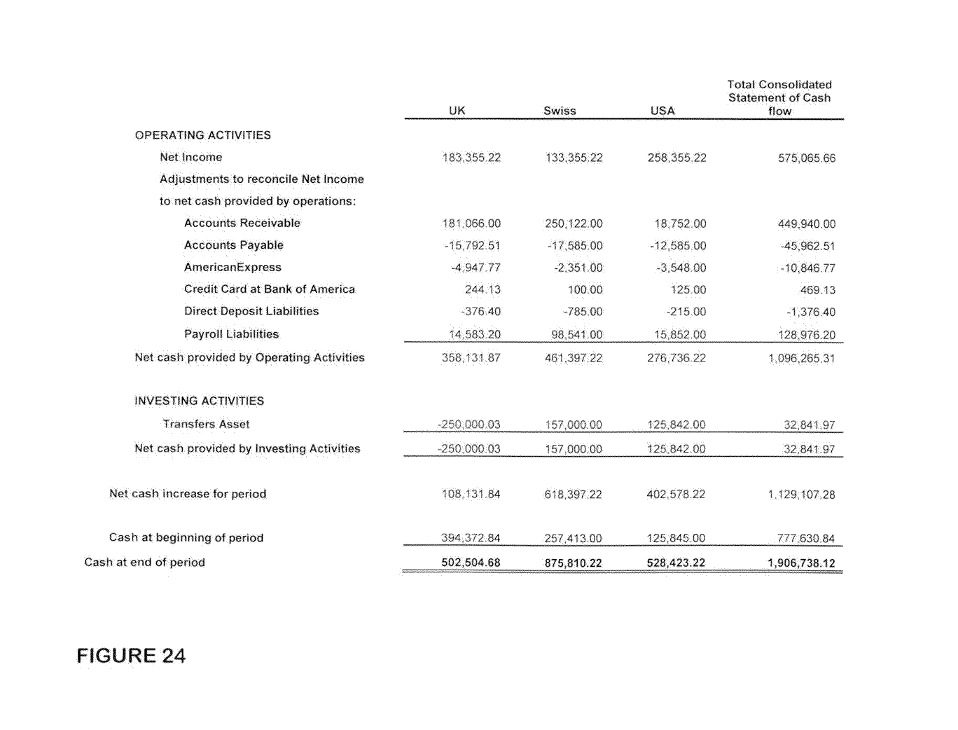

FIG. 24 illustrates an example of a Consolidated Statement of Cash Flow. In financial accounting, a cash flow statement, also known as a statement of cash flows, may be a financial statement that shows how changes in balance sheet accounts and income affect cash and cash equivalents, and breaks the analysis down to operating, investing, and financing activities. Generally, the cash flow statement may be concerned with the flow of cash in and out of the business enterprise. The statement may capture both the current operating results and the accompanying changes in the balance sheet. As an analytical tool, the statement of cash flow may be useful in determining the short-term viability of an entity, particularly its ability to pay bills. International Accounting Standard 7 (IAS 7) is the International Accounting Standard that deals with cash flow statements.

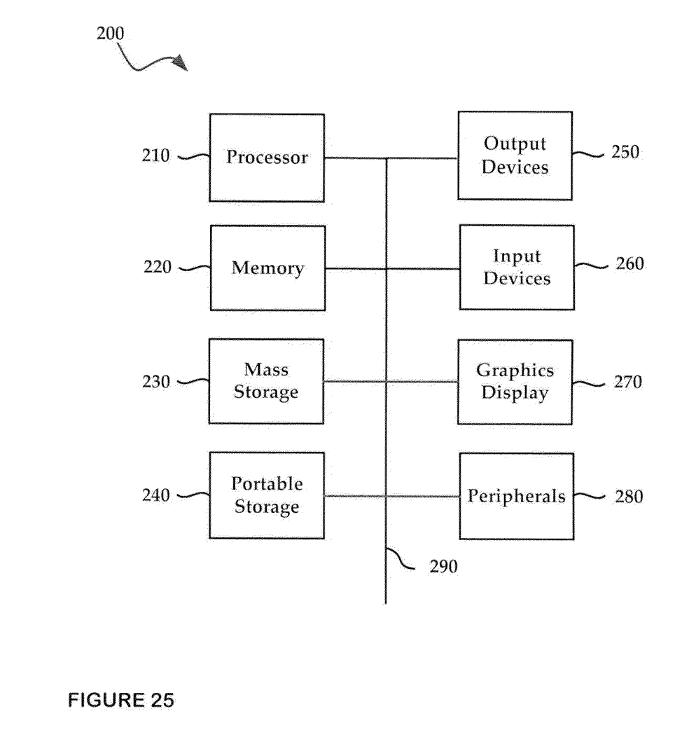

FIG. 25 is a block diagram of an example of a computing system 200 that may be used to implement the examples of the systems and methods in accordance with the present invention. The computing system 200 shown in FIG. 25 may be implemented in the contexts of the likes of computing devices, networks, servers, or combinations thereof. The computing system 200 of FIG. 25 includes a processor 210 and memory 220. Memory 220 stores, in part, instructions and data for execution by processor 210. Memory 220 may store executable code when in operation. The computing system 200 of FIG. 25 further includes a mass storage device 230, portable storage device 240, output devices 250, input devices 260, a graphics display 270, and peripheral devices 280. The components shown in FIG. 25 are depicted as being connected via a single bus 290. The components may be connected through one or more data transport means. For example, processor 210 and memory 220 may be connected via a local microprocessor bus, and the mass storage device 230, peripheral device(s) 280, portable storage device 240, and graphics display 270 may be connected via one or more input/output (I/O) buses.

Mass storage device 230, which may be implemented with a magnetic disk drive or an optical disk drive, is a non-volatile storage device for storing data and instructions for use by processor 210. Mass storage device 230 may store system software for implementing the example system and method of the present invention.

Portable storage device 240 operates in conjunction with a portable non-volatile storage medium, such as a floppy disk, compact disc (CD), digital video disc (DVD), and Blu-ray Disc (BD), to input and output data and code to and from the computing system 200 of FIG. 25. The system software for implementing the example system and method in accordance with the present invention may be stored on such a portable medium and input to the computing system 200 via the portable storage device 240.

Input devices 260 provide a portion of the user interface. Input devices 260 may include an alphanumeric keypad (e.g., a keyboard) for inputting alphanumeric and other information, or a pointing device, such as a mouse, a trackball, stylus, or cursor direction keys. Additionally, the computing system 200 as shown in FIG. 25 includes output devices 250. Suitable output devices include speakers, printers, network interfaces, and monitors.

Graphics display 270 may include a liquid crystal display (LCD) or other suitable display device. Graphics display 270 receives textual and graphical information, and processes the information for output to the display device. Graphics display 270 may be a touch screen, which may also receive input the same as or similar to input devices 260.

Peripherals 280 may include any type of computer support device to add additional functionality to the computing system 200. Peripheral device(s) 280 may include a modem or a router.

The components contained in the computing system 200 of FIG. 25 are those typically found in computing systems that may be suitable for use with the examples of the system and method in accordance with the present invention and are intended to represent a broad category of such computer components that are well known to persons skilled in the art. Thus, the computing system 200 can be a personal computer, hand held computing system, smartphone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, iOS, Android, and other suitable operating systems.

The above-described functions may be composed of instructions that are stored on storage media (e.g., a computer-readable medium). The instructions may be retrieved and executed by the processor 210. Some examples of storage media are memory devices, tapes, disks, and the like. The instructions are operational when executed by the processor 210 to direct the processor to operate in accord with the coded instructions. Persons skilled in the art are familiar with instructions, processor(s), and storage media.

In some examples of the system and method in accordance with the present invention, the computing device 200 may be implemented as a cloud-based computing environment, such as a virtual machine operating within a computing cloud. In other embodiments, the computing device 200 may itself include a cloud-based computing environment, where the functionalities of the computing device 200 are executed in a distributed fashion. Thus, the computing device 200, when configured as a computing cloud, may include pluralities of computing devices in various forms, as will be described in further detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing systems, such as the computing system 200, with each server (or at least a plurality thereof) providing processor and/or storage resources. These servers may manage workloads provided by multiple users (e.g., cloud resource customers or other users). Typically, each user places workload demands upon the cloud that vary in real time, sometimes dramatically. The nature and extent of these variations typically depend on the type of business associated with the user.

It is noteworthy that any hardware platform suitable for performing the processing disclosed herein is suitable for use with the described technology. The terms “computer-readable storage medium” and “computer-readable storage media” as used herein refer to any medium or media that participate in providing instructions to a CPU for execution. Such media can take many forms, including, but not limited to, non-volatile-media and volatile media. Non-volatile media include, for example, optical or magnetic disks, such as a fixed disk. Volatile media include dynamic memory, such as system RAM. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the described technology may be written in any combination of one or more programming languages, including an object oriented programming language such as Java, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the examples of the invention in the form disclosed. Many modifications and variations will be apparent to persons skilled in the art without departing from the scope and spirit of the invention. Examples were chosen in order to best explain the principles of the described technology and its practical application, and to enable persons skilled in the art to understand the various examples in accordance with the invention with various modifications as are suited to the particular use contemplated.

Aspects of the disclosed technology are described above with reference to flowchart illustrations and/or block diagrams of methods, apparatus (systems), and computer program instructions and products according to examples of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various examples in accordance with the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

What is claimed is:

1. A method for producing a consolidated financial statement, comprising:
setting up relationships among entities in a consolidation company;
mapping a chart of accounts from the entities to the consolidation company;
receiving information associated with each of the entities; and
consolidating the information.

2. A method for producing a consolidated financial statement according to claim 1 wherein setting up relationships among entities in a consolidation company comprises:
presenting company information in response to receiving indicia of selection of a company;
if the selected company is finalized, then enabling new child companies to be added;
if the selected company is not finalized, enabling the selected company to be configured by one of adding child companies, if any, or deleting the selected company and all its children;
editing information for the selected company;
changing the selected company's parent, if any;
updating on a server information for the selected company;
selecting a next company or using a wizard to move to a next company, if any; and
in response receiving indicia that the present setup session is completed, saving company configurations and finalizing configured companies.

3. A method for producing a consolidated financial statement according to claim 1 wherein mapping a chart of accounts from the entities to the consolidation company comprises:
enabling a map accounts button or other control;
initializing mapping of accounts in response to selection of the map accounts button or other control;
updating a Mapped To property for a source account with at least a target destination account identification (ID);
if the source account was previously mapped to a different account, then first un-mapping and then re-mapping the source account to the target destination account;
updating the target destination account array by at least adding a source account ID;
providing a confirmation dialog when an account type of the source account does not match an account type of the target destination account;
mapping the source and target destination accounts; and
after the source account is mapped, removing the source account from a source table if a filter has been enabled.

4. A method for producing a consolidated financial statement according to claim 1 wherein receiving information associated with each of the entities comprises:
determining if all associated companies have been activated;
if all associated companies have been activated, determining if an organizational structure comprising all associated companies has been finalized;
if all associated companies have been activated and the organizational structure has been finalized, downloading transactions for all of the associated companies; and
storing the transactions in a database.

5. A method for producing a consolidated financial statement according to claim 4 wherein downloading transactions for all of the associated companies comprises downloading the transactions for each associated company one at a time.

6. A method for producing a consolidated financial statement according to claim 4 wherein downloading transactions for all of the associated companies comprises downloading the transactions for each associated company in blocks of transactions.

7. A method for producing a consolidated financial statement according to claim 4, further comprising:
calculating an Opening Balance, Daily Balances, and Retain Earnings after the transactions have been downloaded; and
storing the calculated Opening Balance, Daily Balances, and Retain Earnings in a second database.

8. A method for producing a consolidated financial statement according to claim 1 wherein consolidating the information comprises:
determining if exchange rates have been obtained for a predetermined consolidation period;
determining if historical accounts are to be processed;
if historical accounts are to be processed, obtaining all account transactions, or if only current account transactions are to be processed, obtaining only current account transactions;
determining if a consolidation account is a Cumulative Translation Adjustment (CTA) account;
applying a CTA formula if the consolidation account is a CTA account or a non-CTA formula if the consolidation is a non-CTA account;
storing the result of the applicable formula in the consolidation account based on the mapping of the accounts; and
moving to the next account or next period until account transactions for all accounts have been processed for the predetermined consolidation period.

9. A method for producing a consolidated financial statement according to claim 8 wherein consolidating the information further comprises posting back the result to accounting software into the consolidation account.
